(19) United States
(12) Patent Application Publication
(10) Pub. No.: US 2026/0008731 A1
(43) Pub. Date: Jan. 8, 2026

(54) METHODS, DEVICES, AND SYSTEMS FOR BIOMASS COMPOSTING AND CO2 CAPTURE

(71) Applicant: North Carolina State University, Raleigh, NC (US)

(72) Inventors: William Sagues, Raleigh, NC (US); Ethan Woods, Raleigh, NC (US)

(21) Appl. No.: 19/105,279

(22) PCT Filed: Aug. 24, 2023
(86) PCT No.: PCT/US2023/031060

§ 371 Date: Feb. 20, 2025

Related U.S. Application Data
(60) Provisional application No. 63/373,520, filed on Aug. 25, 2022.
(60) Provisional application No. 63/489,916, filed on Mar. 13, 2023.

(51) Int. Cl. C05F 17/10; B01D 53/02; B01D 53/14; B01D 53/22; C05F 17/90

(52) U.S. Cl. CPC C05F 17/15; B01D 53/02; B01D 53/14; B01D 53/22; C05F 17/989; B01D 2257/504

(57) ABSTRACT

The present disclosure provides compositions, methods, devices, and systems related to biomass composting and carbon dioxide capture. In particular, the present disclosure provides compositions, methods, devices, and systems for the production of high purity carbon dioxide from a wide variety of biomass feedstock in a more efficient and cost-effective manner than conventional technologies.

### CROSS REFERENCE TO RELATED APPLICATIONS

This application claims priority to and the benefit of U.S. Provisional Patent Application Nos. 63/373,520 filed Aug. 25, 2022, and 63/489,916 filed Mar. 13, 2023, both of which are incorporated herein by reference in their entireties and for all purposes.

### FIELD

The present disclosure provides compositions, methods, devices, and systems related to biomass composting and carbon dioxide capture. In particular, the present disclosure provides compositions, methods, devices, and systems for the production of high purity carbon dioxide from a wide variety of biomass feedstock in a more efficient and cost-effective manner than conventional technologies.

### BACKGROUND

Carbon Dioxide Removal (CDR) is a process by which CO₂ is removed from the atmosphere and sequestered for a long period of time. Removing carbon from the atmosphere is considered an important step for preventing and mitigating the effects of climate change. Additionally, with respect to economic development, sequestering CO₂ can provide federal tax credits, state incentives, and sales on the private market. One technological area within CDR is Biomass Carbon Removal and Storage (BiCRS). BiCRS refers to a wide range of processes that use organisms to remove carbon from the atmosphere and sequester the CO₂ underground or in long-lived products. In some cases, BiCRS pathways have been developed that integrate industrial bioprocesses with CO2 capture; however, most BiCRS processes are inflexible and require a homogenous feedstock supply. Additionally, most industrial bioprocesses with CO2 capture are viewed as capital intensive and challenging to scale. Because of this, industrial bioprocessing with CO2 capture is not widely used. Therefore, there is a need for a scalable and inexpensive bioprocess with CO2 capture, such as industrial composting with CO2 capture, which is both profitable and has a positive impact on climate change.

### SUMMARY

Embodiments of the present disclosure include methods and systems for integrating biomass composting and CO₂ capture into a single, scalable process. In accordance with these embodiments, the method provided herein include inputting a biomass feedstock, one or more additives, and an initial gas composition into one or more bioreactors; incubating the biomass feedstock and the initial gas composition during an incubation time; and obtaining a compost composition and an extracted gas composition comprising CO₂.

In some embodiments, obtaining a compost composition and an extracted gas composition comprising CO₂ comprises post-composting CO₂ capture. In some embodiments, post-composting CO₂ capture includes inputting the initial gas composition into the one or more bioreactors, wherein the initial gas composition comprises air. In some embodiments, the initial gas composition comprises a mixture of oxygen, carbon dioxide, and nitrogen. In some embodiments, the initial gas composition comprises a mixture of oxygen and carbon dioxide, but no nitrogen. In some embodiments, the initial gas composition comprises a mixture of oxygen and nitrogen, but no carbon dioxide. In some embodiments, the initial gas composition comprises a mixture of nitrogen and carbon dioxide, but no oxygen.

In some embodiments, post-composting CO₂ capture includes obtaining the extracted gas composition, wherein the extracted gas composition comprises one or more of CO₂, O₂, and/or N₂. In some embodiments, post-composting CO₂ capture includes obtaining the extracted gas composition, wherein the extracted gas composition is subjected to additional CO₂ capture to produce high purity CO₂.

In some embodiments, the additional CO₂ capture comprises at least one of absorption, adsorption, and/or membrane separation.

In some embodiments, obtaining a compost and an extracted gas composition comprising CO₂ comprises pre-composting CO₂ capture. In some embodiments, pre-composting CO₂ capture includes inputting the initial gas composition into the one or more bioreactors, wherein the initial gas composition comprises high purity O₂ and/or high purity CO₂. In some embodiments, pre-composting CO₂ capture includes obtaining the extracted gas composition, wherein the extracted gas composition comprises high purity CO₂. In some embodiments, pre-composting CO₂ capture includes obtaining the extracted gas composition, wherein the extracted gas composition comprises high purity CO₂ and wherein the high purity CO₂ is captured directly from the bioreactor.

In some embodiments, the biomass feedstock includes one or more of organic biomass feedstock, food waste, animal waste, human waste, agricultural waste, forestry waste, industrial waste, lignocellulosic feedstock, and any combinations thereof.

In some embodiments, the biomass feedstock is pre-treated. In some embodiments, pre-treatment includes steam treatment, chemical treatment, biochemical treatment, and/or mechanical treatment.

In some embodiments, the initial gas composition includes one or more of N₂, CO₂, and/or O₂.

In some embodiments, the incubation time ranges from about 1 second to about 100days. In some embodiments, the incubation time ranges from about 1 second to about 10 days. In some embodiments, the incubation time ranges from about 1 second to about 1 day.

In some embodiments, the biomass feedstock comprises a C: N ratio from about 20:1 to about 40:1. In some embodiments, the biomass feedstock includes one or more of lignocellulose, starches, sugars, organic acids, polysaccharides, peptides, polypeptides, proteins, lipids, including any combination thereof. In some embodiments, the biomass feedstock includes particle sizes from about 1 mm to about 10 m. In some embodiments, the biomass feedstock includes a moisture content from about 5 wt % to about 70 wt %.

In some embodiments, the initial gas composition includes one or more of air, steam, oxygen, and/or CO₂.

In some embodiments, the one or more additives include water, microbial inoculants, purified enzymes, silicate minerals, carbonate minerals, acids, and/or bases.

In some embodiments, the incubation occurs at temperatures from about 30° C. to about 70° C. In some embodiments, the incubation occurs at pH values from about 3 to about 9. In some embodiments, the incubation occurs at bioreactor pressures from about 1 psia to about 100 psia. In some embodiments, the incubation occurs at bioreactor pressures from about 1 psia to about 50 psia. In some embodiments, the incubation occurs at bioreactor pressures from about 1 psia to about 25 psia. In some embodiments, the incubation occurs at bioreactor pressures from about 1 psia to about 10 psia.

In some embodiments, composting and CO₂ capture includes heat recovery.

Embodiments of the present disclosure also include a bioreactor for performing the methods of composting and capturing CO₂ as described herein. In accordance with these embodiments, the bioreactor is configured to perform batch, semi-batch, or continuous composting and CO₂ capture.

In some embodiments, the bioreactor comprises at least one vacuum pump. In some embodiments, the bioreactor comprises one or more valves. In some embodiments, the bioreactor comprises at least one knife gate valve and/or at least one ball valve. In some embodiments, the bioreactor comprises a static vessel, a screw reactor, and/or a rotating drum. In some embodiments, the bioreactor comprises a biomass plug and a back pressure damper configured to control pressure.

Embodiments of the present disclosure also include a system for performing the methods of composting and capturing CO₂ as described herein. In accordance with these embodiments, the system is configured to perform batch, semi-batch, or continuous composting and CO₂ capture.

Other aspects of the disclosure will become apparent by consideration of the detailed description and accompanying drawings.

### BRIEF DESCRIPTION OF THE DRAWINGS

FIG. 1 includes a representative process flow diagram of the post-composting CO₂ capture method with one or more batch or semi-batch bioreactors, according to one embodiment of the present disclosure.

FIG. 2 includes a representative example of the post-composting CO₂ capture method with a batch bioreactor, according to one embodiment of the present disclosure.

FIG. 3 includes a representative example of the post-composting CO₂ capture method with a semi-batch bioreactor, according to one embodiment of the present disclosure.

FIG. 4 includes a representative process flow diagram of the post-composting CO₂ capture method with a continuous bioreactor, according to one embodiment of the present disclosure.

FIG. 5 includes a representative process flow diagram of the pre-composting CO₂ capture method with one or more batch or semi-batch bioreactors, according to one embodiment of the present disclosure.

FIG. 6 includes a representative example of the pre-composting CO₂ capture method with a batch bioreactor, according to one embodiment of the present disclosure.

FIG. 7 includes a representative example of a potential sequence of pre-composting process steps to continuously or semi-continuously produce high purity biogenic CO₂ for capture from composting of biomass materials.

FIG. 8 includes a representative example of the pre-composting CO₂ capture method with a semi-batch bioreactor, according to one embodiment of the present disclosure.

FIG. 9 includes a representative process flow diagram of the pre-composting CO₂ capture method with a continuous bioreactor, according to one embodiment of the present disclosure.

FIG. 10 includes representative data of CO₂ and O₂ concentrations (vol %) in a bioreactor system that employs post-composting CO₂ capture.

FIG. 11 includes representative data of CO₂ and O₂ concentrations (vol %) in a bioreactor system that employs pre-composting CO₂ capture.

FIG. 12 includes representative bioreactor gas composition data demonstrating the process of generating high purity biogenic CO₂ via pre-composting at different pressures (plots on left) and post-composting at different pressures (plots on right).

FIG. 13 includes representative bioreactor gas composition data demonstrating the process of generating high purity biogenic CO₂ via pre-composting under pressurized conditions.

FIG. 14 includes a representative example of a post-composting CO₂ capture system that involves a short incubation time for the gas. The short retention time enables an open system with continuous flow of gas through the bed of biomass. Incubation time is defined as the amount of time the compost feedstock interacts with the gas before removal.

### DETAILED DESCRIPTION

Embodiments of the present disclosure provide technology relating to biomass composting and carbon dioxide capture. In particular, the present disclosure provides compositions, methods, devices, and systems for the production of high purity carbon dioxide from a wide variety of biomass feedstock in a more efficient and cost-effective manner than conventional technologies.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The accompanying drawings, which are incorporated into and constitute a part of this specification, illustrate one or more embodiments of the present application and, together with the detailed description, aid in the explanation of the principles and implementations of the application. The accompanying drawings serve to aid this application, not limit the application.

To facilitate an understanding of the present technology, a number of terms and phrases are defined below. Additional definitions are set forth throughout the detailed description.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges. As used herein, the disclosure of numeric ranges includes the endpoints and each intervening number therebetween with the same degree of precision. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre-determined threshold; conversely, when an entity is said to be “absent”, it means the level or amount of this entity is below a pre-determined threshold. The pre-determined threshold may be the threshold for detectability associated with the particular test used to detect the entity or any other threshold. When an entity is “detected” it is “present”; when an entity is “not detected” it is “absent.”

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, the term “improved” refers to improving a characteristic of an environment as compared to a control environment or as compared to a known average quantity associated with the characteristic in question. As used herein, “improved” does not necessarily demand that the data be statistically significant (e.g., p<0.05); rather, any quantifiable difference demonstrating that one value (e.g., the average treatment value) is different from another (e.g., the average control value) can rise to the level of “improved.”

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components (e.g., a plurality of bioreactors) and software for controlling and directing methods. For example, a “system” or “subsystem” may comprise one or more of, or any combination of, the following: mechanical devices (e.g., bioreactors, valves, filters, and the like), hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “biological system” refers to a collection of genes, enzymes, activities, or functions that operate together to provide a metabolic pathway or metabolic network. A biological system may comprise genes, enzymes, activities, or functions provided by a number of individual organisms. That is, a biological system may be distributed across individual organisms of a microbial community or microbial consortium. Accordingly, a biological system may be described by a collection of genes, enzymes, activities, or functions without identifying individual organisms that provide the genes, enzymes, activities, or functions. A biological system may also be described in terms of nutrient flux, energy flux, electrochemical gradients, metabolic inputs (biological reactants), and metabolic outputs (biological products), e.g., that provide for conversion of energy inputs into energy for biological processes, anabolic synthesis of biomolecules, and elimination of wastes.

As used herein, the terms “microbial”, “microbial organism”, and “microorganism” refer to an organism that exists as a microscopic cell that is included within the domains of Archaea, Bacteria, or Eukarya in the three-domain system, the latter including yeast and filamentous fungi, protozoa, algae, or higher Protista. Therefore, the term is intended to encompass prokaryotic or eukaryotic cells or organisms having a microscopic size and includes bacteria, archaea, and eubacteria of all species as well as eukaryotic microorganisms such as yeast and fungi. Also included are cell cultures of any species that can be cultured for the production of a chemical. The terms “microbial cells” and “microbes” are used interchangeably with the term “microorganism”. The terms “bacteria” and “bacterium” and “archaea” and “archaeon” refer to prokaryotic organisms of the domain Bacteria and Archaea in the three-domain system.

As used herein, the term “naturally occurring” as applied to a nucleic acid, an enzyme, a cell, or an organism, refers to a nucleic acid, enzyme, cell, or organism that is found in nature. For example, a polypeptide or polynucleotide sequence that is present in an organism that can be isolated from a source in nature and that has not been intentionally modified by a human in the laboratory is naturally occurring.

As used herein, the term “non-naturally occurring” as applied to a nucleic acid, an enzyme, a cell, or an organism refers to a nucleic acid, an enzyme, a cell, or an organism that has at least one genetic alteration not normally found in the naturally occurring nucleic acid, enzyme, cell, or organism. Genetic alterations include, for example, modifications introducing expressible nucleic acids encoding metabolic polypeptides, other nucleic acid additions, nucleic acid deletions, and/or other functional disruption of the microbial genetic material. Such modifications include, for example, coding regions and functional fragments thereof, for heterologous, homologous, or both heterologous and homologous polypeptides for the referenced species. Additional modifications include, for example, non-coding regulatory regions in which the modifications alter expression of a gene or operon.

As used herein, “isolate”, “isolated”, “isolated microbe”, and like terms are intended to mean that the one or more microorganisms has been separated from at least one of the materials with which it is associated in a particular environment (for example, soil, water, or a higher multicellular organism). Thus, an “isolated microbe” does not exist in its naturally occurring environment; rather, through the various techniques described herein, the microbe has been removed from its natural setting and placed into a non-naturally occurring state of existence. Thus, the isolated strain may exist as, for example, a biologically pure culture, or as spores (or other forms of the strain) in association with a carrier composition. In certain aspects of the disclosure, the isolated microbes exist as isolated and biologically pure cultures. It will be appreciated by one of skill in the art that an isolated and biologically pure culture of a particular microbe denotes that said culture is substantially free (within scientific reason) of other living organisms and contains only the individual microbe in question. The culture can contain varying concentrations of said microbe, and isolated and biologically pure microbes often necessarily differ from less pure or impure materials. Furthermore, in some aspects, the disclosure provides for certain quantitative measures of the concentration, or purity limitations, that are found within an isolated and biologically pure microbial culture. The presence of these purity values, in certain embodiments, is a further attribute that distinguishes the presently disclosed microbes from those microbes existing in a natural state.

In some embodiments, a microbe can be “endogenous” to an environment. As used herein, a microbe is considered “endogenous” to an environment if the microbe is derived from the environment from which it is sourced. That is, if the microbe is naturally found associated with said environment, then the microbe is endogenous to the environment. In embodiments in which an endogenous microbe is applied to an environment, then the endogenous microbe is applied in an amount that differs from the levels found in the specified environment in nature. Thus, a microbe that is endogenous to a given environment can still improve the environment if the microbe is present in the environment at a level that does not occur naturally and/or if the microbe is applied to the environment with other organisms that are exogenous to the environment and/or endogenous to the environment and present at a level that does not occur naturally.

In some embodiments, a microbe can be “exogenous” (also termed “heterologous”) to an environment. As used herein, a microbe is considered “exogenous” to an environment if the microbe is not derived from the environment from which it is sourced. That is, if the microbe is not naturally found associated with the environment, then the microbe is exogenous to the environment. For example, a microbe that is normally associated with a first environment may be considered exogenous to a second environment that naturally lacks said microbe.

As used herein, “environmental sample” means a sample taken or acquired from any part of the environment (e.g., ecosystem, ecological niche, habitat, etc.) An environmental sample may include liquid samples from a river, lake, pond, ocean, glaciers, icebergs, rain, snow, sewage, reservoirs, tap water, drinking water, etc.; solid samples from soil, compost, sand, rocks, concrete, wood, brick, sewage, etc.; and gaseous samples from the air, underwater heat vents, industrial exhaust, vehicular exhaust, etc.

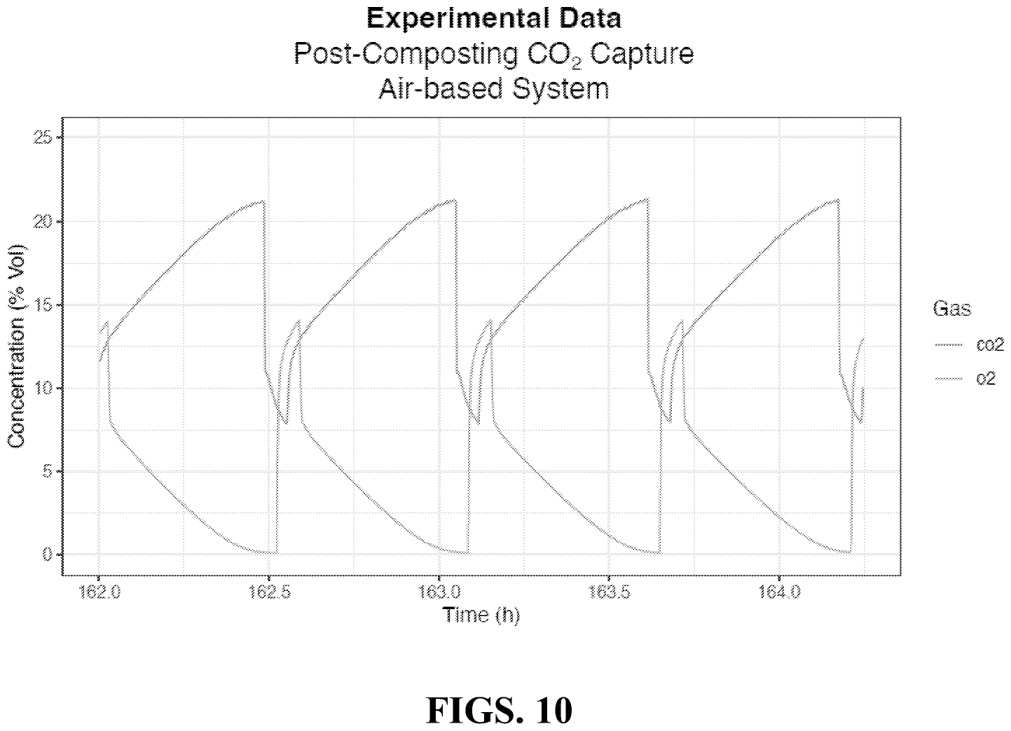

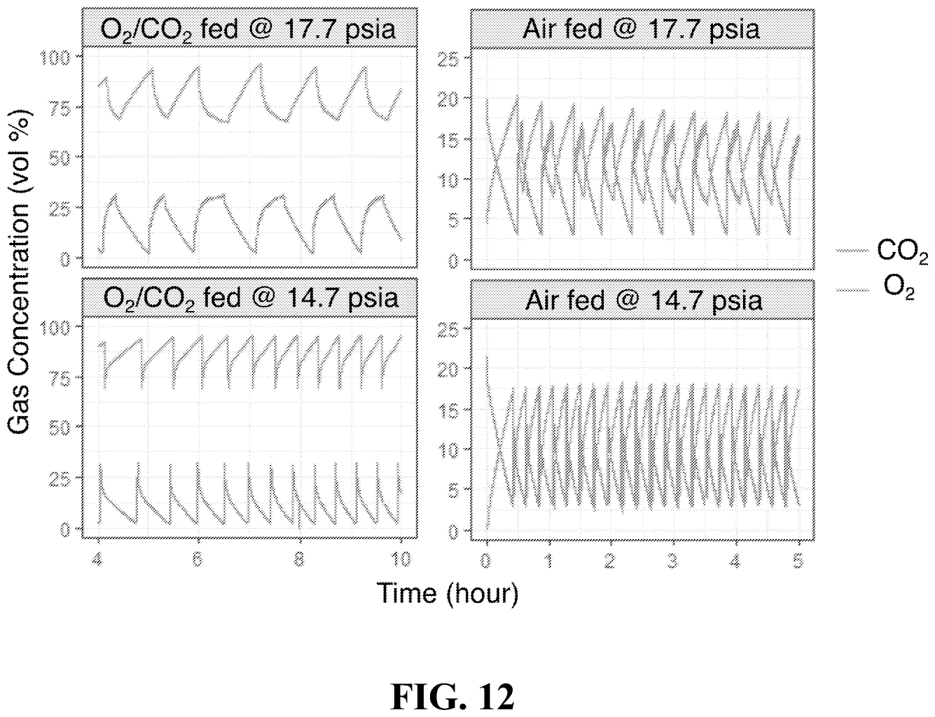

As used herein, “post-composting CO₂ capture” and bioreactors/systems thereof generally refer to a composting system in which air is used as the oxidant to produce and extract gas of relatively high CO₂ concentration (e.g., 5-30 vol %) from the composting bioreactor (see, e.g., FIGS. 10 and 12). The CO₂ concentration of the extracted gas is considered high relative to currently available composting systems. The O₂ concentration in the bioreactors/systems thereof is allowed to decrease to very low concentration (e.g., <1 vol %), relative to currently available composting systems. The extracted gas is processed downstream, or post-composting, to separate CO₂ from non-CO₂ components and generate a CO₂ product. Post-composting CO₂ capture is analogous to post-combustion CO₂ capture, which is a common term used in traditional heat and power generation with CO₂ capture systems.

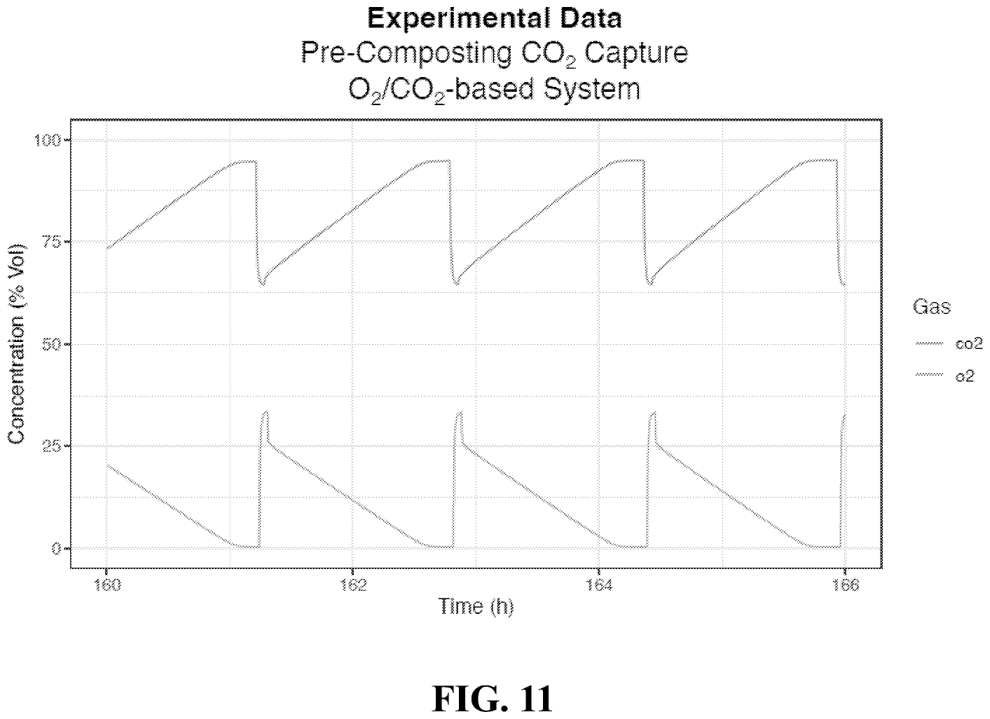

As used herein, “pre-composting CO₂ capture” and bioreactors/systems thereof generally refer to a composting system in which pure O₂ or a mixture of O₂ and CO₂ is used as the oxidant to produce and extract gas of relatively high CO₂ concentration (e.g., >80 vol %) from the composting bioreactor. The CO₂ concentration is considered high relative to currently available composting systems. In some cases, pre-composting CO₂ capture bioreactors/systems enable extraction of gas having CO₂ concentrations that are higher than for post-composing CO₂ capture. The O₂ concentration in the bioreactors/systems thereof is allowed to decrease to very low concentration (e.g., <1 vol %), relative to currently available composting systems. The very high CO₂ concentration is achieved by separating O₂ from air prior to feeding the oxidant to the composting the reactor, or pre-composting separation. Further separation of CO₂ from the extracted gas may or may not be required post-composting. Pre-composting CO₂ capture is analogous to pre-combustion CO₂ capture, which is a common term used in traditional heat and power generation with CO₂ capture systems (see, e.g., FIGS. 11, 12 and 13).

### Description

Embodiments of the present disclosure provide technology relating to biomass composting and carbon dioxide capture. In particular, the present disclosure provides compositions, methods, devices, and systems for the production of high purity carbon dioxide from a wide variety of biomass feedstock in a more efficient and cost-effective manner than conventional technologies.

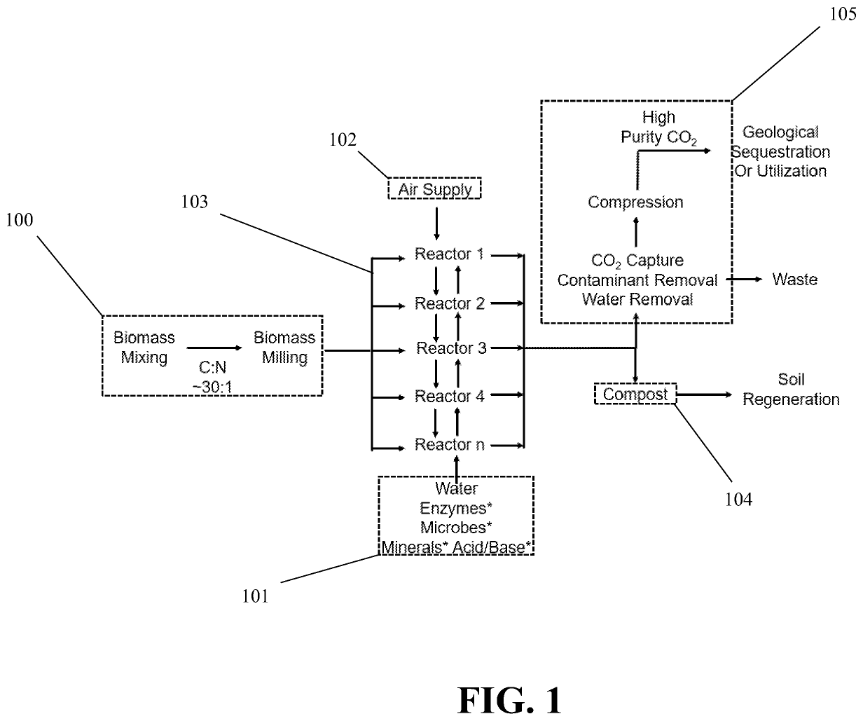

As shown in the representative diagram in FIG. 1, embodiments of the present disclosure include a process for post-composting CO₂ capture. In accordance with these embodiments, the composting and CO₂ capture method is performed using one or more batch or semi-batch bioreactors 103. With reference to FIG. 1, a biomass feedstock 100, one or more additives 101, and an initial gas composition 102 (e.g., initial gas of various compositions including but not limited to an air supply) are input into the one or more bioreactors 103.

With continued reference to FIG. 1, the biomass feedstock 100 includes one or more of organic biomass feedstock, food waste, animal waste, human waste, agricultural waste, forestry waste, industrial waste, and/or lignocellulosic feedstock, including any combination thereof. In some embodiments, the biomass feedstock 100 includes one or more of lignocellulose, starches, sugars, organic acids, polysaccharides, peptides, polypeptides, proteins, and/or lipids, including any combination thereof. As described further herein, the methods of the present disclosure are not limited to a single type, quality, or purity of feedstock, but is well suited for use with inconsistent, diverse, and low quality biomass feedstocks, as compared to most other, currently available technologies.

In some embodiments, the biomass feedstock 100 includes particle sizes that range from about 1 mm to about 10 m. In some embodiments, the biomass feedstock 100 includes particle sizes that range from about 10 mm to about 10 m. In some embodiments, the biomass feedstock 100 includes particle sizes that range from about 100 mm to about 10 m. In some embodiments, the biomass feedstock 100 includes particle sizes that range from about 1000 mm to about 10 m. In some embodiments, the biomass feedstock 100 includes particle sizes that range from about 1 mm to about 1 m. In some embodiments, the biomass feedstock 100 includes particle sizes that range from about 10 mm to about 10 cm. In some embodiments, the biomass feedstock 100 includes particle sizes that range from about 100 mm to about 100 cm.

In some embodiments, the biomass feedstock 100 includes a moisture content from about 5 wt % to about 70 wt %. In some embodiments, the biomass feedstock 100 includes a moisture content from about 10 wt % to about 70 wt %. In some embodiments, the biomass feedstock 100 includes a moisture content from about 15 wt % to about 70 wt %. In some embodiments, the biomass feedstock 100 includes a moisture content from about 20 wt % to about 70 wt %. In some embodiments, the biomass feedstock 100 includes a moisture content from about 25 wt % to about 70 wt %. In some embodiments, the biomass feedstock 100 includes a moisture content from about 30 wt % to about 70 wt %. In some embodiments, the biomass feedstock 100 includes a moisture content from about 35 wt % to about 70 wt %. In some embodiments, the biomass feedstock 100 includes a moisture content from about 40 wt % to about 70 wt %. In some embodiments, the biomass feedstock 100 includes a moisture content from about 45 wt % to about 70 wt %. In some embodiments, the biomass feedstock 100 includes a moisture content from about 50 wt % to about 70 wt %. In some embodiments, the biomass feedstock 100 includes a moisture content from about 55 wt % to about 70 wt %. In some embodiments, the biomass feedstock 100 includes a moisture content from about 60 wt % to about 70 wt %. In some embodiments, the biomass feedstock 100 includes a moisture content from about 65 wt % to about 70 wt %. In some embodiments, the biomass feedstock 100 includes a moisture content from about 5 wt % to about 65 wt %. In some embodiments, the biomass feedstock 100 includes a moisture content from about 5 wt % to about 60 wt %. In some embodiments, the biomass feedstock 100 includes a moisture content from about 5 wt % to about 55 wt %. In some embodiments, the biomass feedstock 100 includes a moisture content from about 5 wt % to about 50 wt %. In some embodiments, the biomass feedstock 100 includes a moisture content from about 5 wt % to about 45 wt %. In some embodiments, the biomass feedstock 100 includes a moisture content from about 5 wt % to about 40 wt %. In some embodiments, the biomass feedstock 100 includes a moisture content from about 5 wt % to about 35 wt %. In some embodiments, the biomass feedstock 100 includes a moisture content from about 5 wt % to about 30 wt %. In some embodiments, the biomass feedstock 100 includes a moisture content from about 5 wt % to about 25 wt %. In some embodiments, the biomass feedstock 100 includes a moisture content from about 5 wt % to about 20 wt %. In some embodiments, the biomass feedstock 100 includes a moisture content from about 5 wt % to about 15 wt %. In some embodiments, the biomass feedstock 100 includes a moisture content from about 5 wt % to about 10 wt %. In some embodiments, the biomass feedstock 100 includes a moisture content from about 10 wt % to about 50 wt %. In some embodiments, the biomass feedstock 100 includes a moisture content from about 20 wt % to about 60 wt %. In some embodiments, the biomass feedstock 100 includes a moisture content from about 30 wt % to about 50 wt %. In some embodiments, the biomass feedstock 100 includes a moisture content from about 40 wt % to about 60 wt %.

In some embodiments, the biomass feedstock 100 includes a moisture content from about 5 wt % to about 70 wt %. In some embodiments, the biomass feedstock 100 includes a moisture content from about 10 wt % to about 70 wt %. In some embodiments, the biomass feedstock 100 includes a moisture content from about 15 wt % to about 70 wt %. In some embodiments, the biomass feedstock 100 includes a moisture content from about 20 wt % to about 70 wt %. In some embodiments, the biomass feedstock 100 includes a moisture content from about 25 wt % to about 70 wt %. In some embodiments, the biomass feedstock 100 includes a moisture content from about 30 wt % to about 70 wt %. In some embodiments, the biomass feedstock 100 includes a moisture content from about 35 wt % to about 70 wt %. In some embodiments, the biomass feedstock 100 includes a moisture content from about 40 wt % to about 70 wt %. In some embodiments, the biomass feedstock 100 includes a moisture content from about 45 wt % to about 70 wt %. In some embodiments, the biomass feedstock 100 includes a moisture content from about 50 wt % to about 70 wt %. In some embodiments, the biomass feedstock 100 includes a moisture content from about 55 wt % to about 70 wt %. In some embodiments, the biomass feedstock 100 includes a moisture content from about 60 wt % to about 70 wt %. In some embodiments, the biomass feedstock 100 includes a moisture content from about 65 wt % to about 70 wt %. In some embodiments, the biomass feedstock 100 includes a moisture content from about 5 wt % to about 65 wt %. In some embodiments, the biomass feedstock 100 includes a moisture content from about 5 wt % to about 60 wt %. In some embodiments, the biomass feedstock 100 includes a moisture content from about 5 wt % to about 55 wt %. In some embodiments, the biomass feedstock 100 includes a moisture content from about 5 wt % to about 50 wt %. In some embodiments, the biomass feedstock 100 includes a moisture content from about 5 wt % to about 45 wt %. In some embodiments, the biomass feedstock 100 includes a moisture content from about 5 wt % to about 40 wt %. In some embodiments, the biomass feedstock 100 includes a moisture content from about 5 wt % to about 35 wt %. In some embodiments, the biomass feedstock 100 includes a moisture content from about 5 wt % to about 30 wt %. In some embodiments, the biomass feedstock 100 includes a moisture content from about 5 wt % to about 25 wt %. In some embodiments, the biomass feedstock 100 includes a moisture content from about 5 wt % to about 20 wt %. In some embodiments, the biomass feedstock 100 includes a moisture content from about 5 wt % to about 15 wt %. In some embodiments, the biomass feedstock 100 includes a moisture content from about 5 wt % to about 10 wt %. In some embodiments, the biomass feedstock 100 includes a moisture content from about 10 wt % to about 50 wt %. In some embodiments, the biomass feedstock 100 includes a moisture content from about 20 wt % to about 60 wt %. In some embodiments, the biomass feedstock 100 includes a moisture content from about 30 wt % to about 50 wt %. In some embodiments, the biomass feedstock 100 includes a moisture content from about 40 wt % to about 60 wt %.

In the illustrated embodiment of FIG. 1, the biomass feedstock 100 includes a C:N ratio of about 30:1. In some embodiments, the biomass feedstock 100 includes a C:N ratio ranging from about 20:1 to 40:1. In some embodiments, the biomass feedstock 100 includes a C:N ratio ranging from about 25:1 to 40:1. In some embodiments, the biomass feedstock 100 includes a C:N ratio ranging from about 30:1 to 40:1. In some embodiments, the biomass feedstock 100 includes a C:N ratio ranging from about 20:1 to 35:1. In some embodiments, the biomass feedstock 100 includes a C:N ratio ranging from about 20:1 to 30:1.

In some embodiments, the biomass feedstock 100 is pre-treated. In some embodiments, pre-treatment includes steam treatment, chemical treatment, biochemical treatment, and/or mechanical treatment, including any combinations thereof.

With continued reference to FIG. 1, in the illustrated embodiment, the initial gas composition 102 is air. In some embodiments, the initial gas composition 102 includes one or more of N₂, CO₂, and/or O₂. In some embodiments, the initial gas composition 102 includes one or more of air, steam, oxygen, and/or CO₂.

With continued reference to FIG. 1, the one or more additives 101 include water, microbial inoculants, purified enzymes, silicate minerals, carbonate minerals, acids, and/or bases, including any combinations thereof.

With continued reference to FIG. 1, in some embodiments, incubation occurs at bioreactor pressures ranging from about 1 psia to about 100 psia. In some embodiments, incubation occurs at bioreactor pressures ranging from about 1 psia to about 75 psia. In some embodiments, incubation occurs at bioreactor pressures ranging from about 1 psia to about 50 psia. In some embodiments, incubation occurs at bioreactor pressures ranging from about 1 psia to about 40 psia. In some embodiments, incubation occurs at bioreactor pressures ranging from about 1 psia to about 30 psia. In some embodiments, incubation occurs at bioreactor pressures ranging from about 1 psia to about 20 psia. In some embodiments, incubation occurs at bioreactor pressures ranging from about 1 psia to about 10 psia. In some embodiments, incubation occurs at bioreactor pressures ranging from about 5 psia to about 100 psia. In some embodiments, incubation occurs at bioreactor pressures ranging from about 10 psia to about 100 psia. In some embodiments, incubation occurs at bioreactor pressures ranging from about 20 psia to about 100 psia. In some embodiments, incubation occurs at bioreactor pressures ranging from about 30 psia to about 100 psia. In some embodiments, incubation occurs at bioreactor pressures ranging from about 40 psia to about 100 psia. In some embodiments, incubation occurs at bioreactor pressures ranging from about 50 psia to about 100 psia. In some embodiments, incubation occurs at bioreactor pressures ranging from about 75 psia to about 100 psia. In some embodiments, incubation occurs at bioreactor pressures ranging from about 5 psia to about 40 psia. In some embodiments, incubation occurs at bioreactor pressures ranging from about 5 psia to about 35 psia. In some embodiments, incubation occurs at bioreactor pressures ranging from about 5 psia to about 30 psia. In some embodiments, incubation occurs at bioreactor pressures ranging from about 5 psia to about 25 psia. In some embodiments, incubation occurs at bioreactor pressures ranging from about 5 psia to about 20 psia. In some embodiments, incubation occurs at bioreactor pressures ranging from about 5 psia to about 15 psia. In some embodiments, incubation occurs at bioreactor pressures ranging from about 5 psia to about 10 psia. In some embodiments, incubation occurs at bioreactor pressures ranging from about 10 psia to about 40 psia. In some embodiments, incubation occurs at bioreactor pressures ranging from about 15 psia to about 30 psia. In some embodiments, incubation occurs at bioreactor pressures ranging from about 25 psia to about 40 psia.

In some embodiments, incubation occurs at temperatures ranging from about 30° C. to about 70° C. In some embodiments, incubation occurs at temperatures ranging from about 35° C. to about 70° C. In some embodiments, incubation occurs at temperatures ranging from about 40° C. to about 70° C. In some embodiments, incubation occurs at temperatures ranging from about 45° C. to about 70° C. In some embodiments, incubation occurs at temperatures ranging from about 50° C. to about 70° C. In some embodiments, incubation occurs at temperatures ranging from about 55° C. to about 70° C. In some embodiments, incubation occurs at temperatures ranging from about 60° C. to about 70° C. In some embodiments, incubation occurs at temperatures ranging from about 65° C. to about 70° C. In some embodiments, incubation occurs at temperatures ranging from about 30° C. to about 65° C. In some embodiments, incubation occurs at temperatures ranging from about 30° C. to about 60° C. In some embodiments, incubation occurs at temperatures ranging from about 30° C. to about 55° C. In some embodiments, incubation occurs at temperatures ranging from about 30° C. to about 50° C. In some embodiments, incubation occurs at temperatures ranging from about 30° C. to about 45° C. In some embodiments, incubation occurs at temperatures ranging from about 30° C. to about 40° C. In some embodiments, incubation occurs at temperatures ranging from about 30° C. to about 35° C. In some embodiments, incubation occurs at temperatures ranging from about 40° C. to about 60° C. In some embodiments, incubation occurs at temperatures ranging from about 50° C. to about 70° C. In some embodiments, incubation occurs at temperatures ranging from about 45° C. to about 55° C.

In some embodiments, incubation occurs at pH values ranging from about 3 to about 9. In some embodiments, incubation occurs at pH values ranging from about 4 to about 9. In some embodiments, incubation occurs at pH values ranging from about 5 to about 9. In some embodiments, incubation occurs at pH values ranging from about 6 to about 9. In some embodiments, incubation occurs at pH values ranging from about 7 to about 9. In some embodiments, incubation occurs at pH values ranging from about 8 to about 9. In some embodiments, incubation occurs at pH values ranging from about 3 to about 8. In some embodiments, incubation occurs at pH values ranging from about 3 to about 7. In some embodiments, incubation occurs at pH values ranging from about 3 to about 6. In some embodiments, incubation occurs at pH values ranging from about 3 to about 5. In some embodiments, incubation occurs at pH values ranging from about 3 to about 4. In some embodiments, incubation occurs at pH values ranging from about 4 to about 8. In some embodiments, incubation occurs at pH values ranging from about 5 to about 7.

With continued reference to FIG. 1, after incubating the biomass feedstock 100 and the initial gas composition 102, a compost composition 104 and an extracted gas composition 105 comprising CO₂ are obtained. In the illustrated embodiment, the compost composition 104 is used for soil regeneration, but can be used for any purpose, including but not limited to, use as soil additives for fertilization, regeneration, erosion prevention, and the like. In the illustrated embodiment, the extracted gas composition 105 comprising CO₂ undergoes additional CO₂ capture. In some embodiments, additional CO₂ capture includes at least one of absorption, adsorption, and/or membrane separation, including any combinations thereof. In the illustrated embodiment, after additional CO₂ capture, high purity CO₂ is produced. The high purity CO₂ can be utilized in other processes or geologically sequestered.

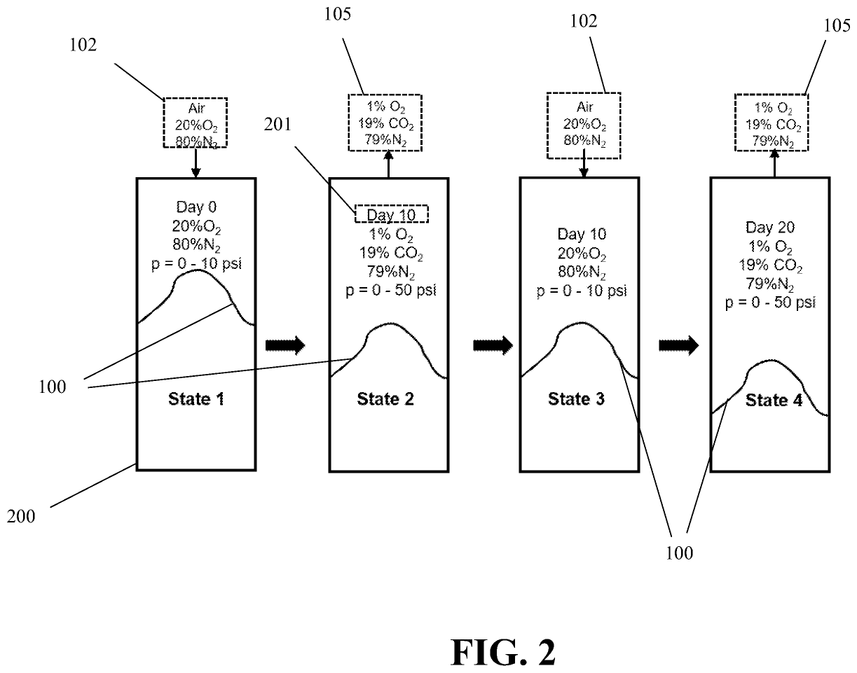

FIG. 2 includes a representative example of post-composting CO₂ capture, where the composting and CO₂ capture method is used with a batch bioreactor 200. With reference to FIG. 2, post-composting CO₂ capture using a batch bioreactor 200 is illustrated in four states. State 1 illustrates the start of post-composting CO₂ capture, where the biomass feedstock 100, including the one or more additives 101, is input into the batch bioreactor 200 with the initial gas composition 102. In the illustrated embodiment, the initial gas composition 102 is air; however, other initial gas compositions can be used, as described further herein. In some embodiments, the batch bioreactor 200 includes a static vessel, screw reactor, and/or rotating drum, including any combination thereof.

With continued reference to FIG. 2, State 2 illustrates post-composting CO₂ capture after an incubation time 201. In some embodiments, the incubation time 201 ranges from about 1 day to about 100 days. In some embodiments, the incubation time 201 ranges from about 1 day to about 75 days. In some embodiments, the incubation time 201 ranges from about 1 day to about 50 days. In some embodiments, the incubation time 201 ranges from about 1 day to about 25 days. In some embodiments, the incubation time 201 ranges from about 1 day to about 10 days. In some embodiments, the incubation time 201 ranges from about 10 days to about 100 days. In some embodiments, the incubation time 201 ranges from about 25 days to about 100 days. In some embodiments, the incubation time 201 ranges from about 50 days to about 100 days. In some embodiments, the incubation time 201 ranges from about 75 days to about 100 days.

In some embodiments, the incubation time 201 ranges from about 1 second to about 10 days. In some embodiments, the incubation time 201 ranges from about 1 second to about 5 days. In some embodiments, the incubation time 201 ranges from about 1 second to about 1 day. In some embodiments, the incubation time 201 ranges from about 1 second to about 16 hours. In some embodiments, the incubation time 201 ranges from about 1 second to about 8 hours. In some embodiments, the incubation time 201 ranges from about 1 second to about 1 hour. In some embodiments, the incubation time 201 ranges from about 10 minutes to about 10 days. In some embodiments, the incubation time 201 ranges from about 30 minutes to about 10 days. In some embodiments, the incubation time 201 ranges from about 1 hour to about 10 days. In some embodiments, the incubation time 201 ranges from about 8 hours to about 10 days. In some embodiments, the incubation time 201 ranges from about 16 hours to about 10 days. In some embodiments, the incubation time 201 ranges from about 24 hours to about 10 days. In some embodiments, the incubation time 201 ranges from about 2 days to about 10 days. In some embodiments, the incubation time 201 ranges from about 5 days to about 10 days.

In accordance with the above, the incubation time can be predetermined based on the desired conditions being used. In other embodiments, the incubation time is not predetermined. For example, in some embodiments, biomass is incubated for an amount of time that is a function of O₂ and CO₂ concentration, and is not predetermined. In some embodiments, the incubation time ends when the O₂ concentration reaches a desired concentration (e.g., 0.5%). In other embodiments, the incubation time ends once the CO₂ concentration exceeds a desired concentration (e.g., 95%).

In some embodiments, incubation occurs at pressures ranging from about 1 psia to about 100 psia within the batch bioreactor 200. In some embodiments, incubation occurs at bioreactor pressures ranging from about 1 psia to about 75 psia. In some embodiments, incubation occurs at bioreactor pressures ranging from about 1 psia to about 50 psia. In some embodiments, incubation occurs at bioreactor pressures ranging from about 1 psia to about 25 psia. In some embodiments, incubation occurs at bioreactor pressures ranging from about 25 psia to about 100 psia. In some embodiments, incubation occurs at bioreactor pressures ranging from about 50 psia to about 100 psia. In some embodiments, incubation occurs at bioreactor pressures ranging from about 75 psia to about 100 psia. In some embodiments, incubation occurs at bioreactor pressures ranging from about 25 psia to about 75 psia.

In some embodiments, the batch bioreactor 200 (in State 2) increases in pressure compared to State 1. In the illustrated embodiment, the batch bioreactor 200 includes at least one vacuum pump. The extracted gas composition 105 is pumped out of the batch bioreactor 200. In the illustrated embodiment, the extracted gas composition 105 includes O₂, CO₂ and N₂. In some embodiments, the extracted gas composition 105 includes one or more of O₂, CO₂ and/or N₂.

With continued reference to FIG. 2, State 3 illustrates post-composting CO₂ capture after the initial gas composition 102 is input into the reactor after incubating for the predetermined incubating time 201 and extraction of the extracted gas composition 105. In the illustrated embodiment, at least a portion of the biomass feedstock 100 remains in the batch bioreactor 200. In the illustrated embodiment, the batch bioreactor 200 (in State 3) decreases in pressure compared to State 2.

With continued reference to FIG. 2, State 4 illustrates post-composting CO₂ capture after the predetermined incubating time 201 elapses again. In some embodiments, the predetermined incubation is the same in each cycle. In other embodiments, the predetermined incubation time is different for one or more cycles. In the illustrated embodiment, the predetermined incubating time 201 is 10 days, though other predetermined incubation times can be used, as described further herein. In the illustrated embodiment, at State 4, post-composting CO₂ capture has occurred for a total of 20 days. The extracted gas composition 105 is pumped out of the batch bioreactor 200. In the illustrated embodiment, the extracted gas composition 105 includes N₂, O₂, and CO₂. State 1 to State 4 illustrates an example post-composting CO₂ capture cycle that can be repeated until all available carbon within the biomass feedstock 100 has been converted to CO₂ during incubation in the batch bioreactor 200. Once all available carbon within the biomass feedstock 100 has been converted to CO₂ during incubation, the compost composition 104 is extracted from the batch bioreactor 200.

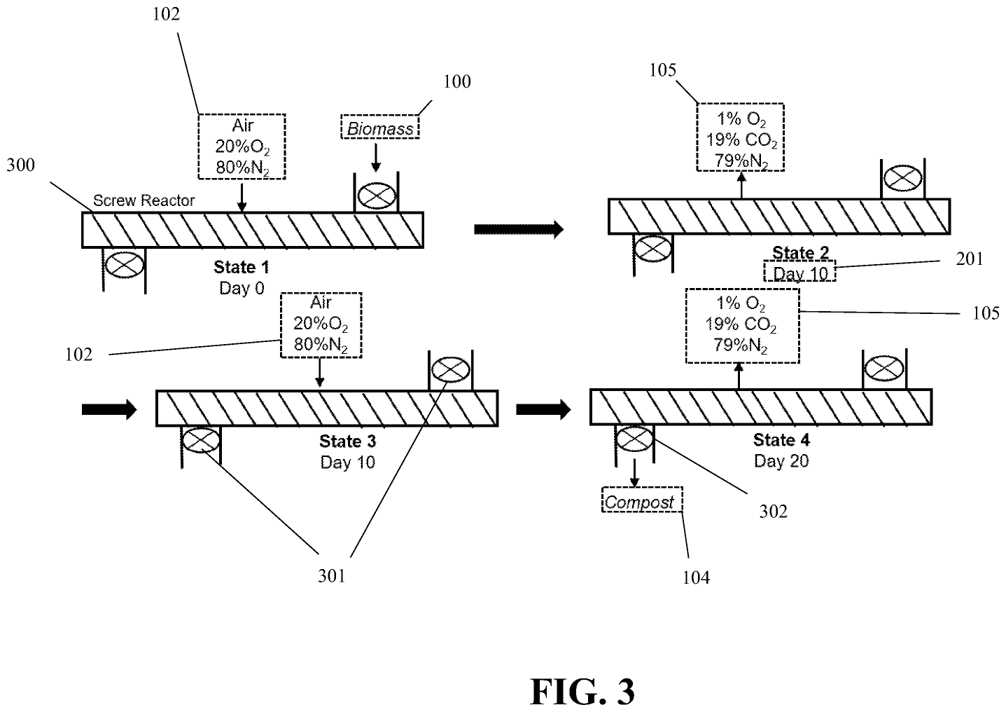

FIG. 3 illustrates an example of post-composting CO₂ capture, where the composting and CO₂ capture method is used with a semi-batch bioreactor 300. With reference to FIG. 3, post-composting CO₂ capture using a semi-batch bioreactor 300 is illustrated in four states. State 1 illustrates the start of post-composting CO₂ capture, where the biomass feedstock 100, including the one or more additives 101, is input into the semi-batch bioreactor 300 with the initial gas composition 102. In the illustrated embodiment, the initial gas composition 102 is air. In the illustrated embodiment, the semi-batch bioreactor 300 includes a screw reactor. In some embodiments, the semi-batch bioreactor 300 includes a static vessel or rotating drum. In the illustrated embodiment, the semi-batch bioreactor 300 includes one or more valves 301, specifically knife gate valves. In some embodiments, the semi-batch bioreactor 300 includes at least one knife gate valve and/or ball valve.

With continued reference to FIG. 3, State 2 illustrates post-composting CO₂ capture after a predetermined incubating time 201. In the illustrated embodiment, the predetermined incubating time 201 is about 10 days, though other predetermined incubation times can be used, as described further herein. In some embodiments, the predetermined incubating time 201 ranges from about 1 day to about 100 days. In some embodiments, the predetermined incubating time 201 ranges from about 1 day to about 100 days. In some embodiments, the predetermined incubating time 201 ranges from about 1 day to about 75 days. In some embodiments, the predetermined incubating time 201 ranges from about 1 day to about 50 days. In some embodiments, the predetermined incubating time 201 ranges from about 1 day to about 25 days. In some embodiments, the predetermined incubating time 201 ranges from about 1 day to about 10 days. In some embodiments, the predetermined incubating time 201 ranges from about 10 days to about 100 days. In some embodiments, the predetermined incubating time 201 ranges from about 25 days to about 100 days. In some embodiments, the predetermined incubating time 201 ranges from about 50 days to about 100 days. In some embodiments, the predetermined incubating time 201 ranges from about 75 days to about 100 days.

In the illustrated embodiment of FIG. 3, the semi-batch bioreactor 300 includes at least one vacuum pump. The extracted gas composition 105 is pumped out of the semi-batch bioreactor 300. In the illustrated embodiment, the extracted gas composition 105 includes O₂, CO₂, and N₂. In some embodiments, the extracted gas composition 105 includes one or more of O₂, CO₂ and/or N₂.

With continued reference to FIG. 3, State 3 illustrates post-composting CO₂ capture after the initial gas composition 102 is input into the reactor after incubating for the predetermined incubating time 201 and extraction of the extracted gas composition 105. In the illustrated embodiment, the biomass feedstock 100 remains in the semi-batch bioreactor 300.

With continued reference to FIG. 3, State 4 illustrates post-composting CO₂ capture after the predetermined incubating time 201 elapses again. In some embodiments, the predetermined incubation is the same in each cycle. In other embodiments, the predetermined incubation time is different for one or more cycles. In the illustrated embodiment, the predetermined incubating time 201 is about 10 days, though other predetermined incubation times can be used, as described further herein. In some embodiments, the predetermined incubating time 201 ranges from about 1 day to about 100 days. In some embodiments, the predetermined incubating time 201 ranges from about 1 day to about 100 days. In some embodiments, the predetermined incubating time 201 ranges from about 1 day to about 75 days. In some embodiments, the predetermined incubating time 201 ranges from about 1 day to about 50 days. In some embodiments, the predetermined incubating time 201 ranges from about 1 day to about 25 days. In some embodiments, the predetermined incubating time 201 ranges from about 1 day to about 10 days. In some embodiments, the predetermined incubating time 201 ranges from about 10 days to about 100 days. In some embodiments, the predetermined incubating time 201 ranges from about 25 days to about 100 days. In some embodiments, the predetermined incubating time 201 ranges from about 50 days to about 100 days. In some embodiments, the predetermined incubating time 201 ranges from about 75 days to about 100 days.

In the illustrated embodiment of FIG. 3, at State 4, post-composting CO₂ capture has occurred for a total of 20 days. The extracted gas composition 105 is pumped out of the semi-batch bioreactor 300. State 1 to State 4 illustrates an example post-composting CO₂ capture cycle that can be repeated until all available carbon within the biomass feedstock 100 has been converted to CO₂ during incubation in the semi-batch bioreactor 300. Once all available carbon within the biomass feedstock 100 has been converted to CO₂ during incubation, the compost composition 104 is extracted from the semi-batch bioreactor 300. In the illustrated embodiment, the compost composition 104 is extracted through one of the knife-gate valves 302.

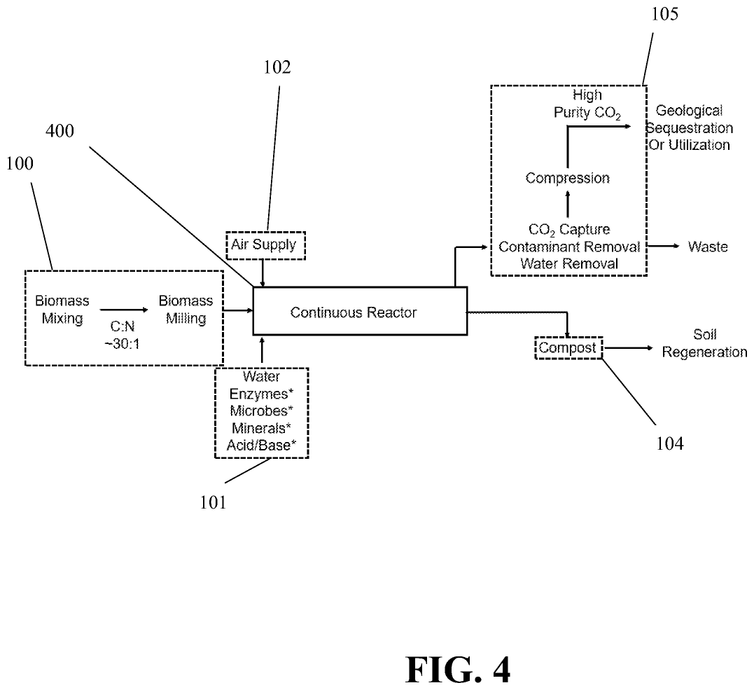

FIG. 4 illustrates a general process flow diagram of post-composting CO₂ capture, where the composting and CO₂ capture method is used with a continuous bioreactor. With reference to FIG. 4, a biomass feedstock 100, one or more additives 101, and an initial gas composition 102 are input into a continuous bioreactor 400.

With continued reference to FIG. 4, the biomass feedstock 100 includes one or more of organic biomass feedstock, food waste, animal waste, human waste, agricultural waste, forestry waste, industrial waste, and/or lignocellulosic feedstock. In some embodiments, the biomass feedstock 100 includes one or more of lignocellulose, starches, sugars, organic acids, polysaccharides, peptides, polypeptides, proteins, and/or lipids.

In some embodiments, the biomass feedstock 100 includes particle sizes from about 1 mm to about 10 m. In some embodiments, the biomass feedstock 100 includes particle sizes that range from about 10 mm to about 10 m. In some embodiments, the biomass feedstock 100 includes particle sizes that range from about 100 mm to about 10 m. In some embodiments, the biomass feedstock 100 includes particle sizes that range from about 1000 mm to about 10 m. In some embodiments, the biomass feedstock 100 includes particle sizes that range from about 1 mm to about 1 m. In some embodiments, the biomass feedstock 100 includes particle sizes that range from about 10 mm to about 10 cm. In some embodiments, the biomass feedstock 100 includes particle sizes that range from about 100 mm to about 100 cm.

In some embodiments, the biomass feedstock 100 includes a moisture content from about 5 wt % to about 70 wt %. In some embodiments, the biomass feedstock 100 includes a moisture content from about 10 wt % to about 70 wt %. In some embodiments, the biomass feedstock 100 includes a moisture content from about 15 wt % to about 70 wt %. In some embodiments, the biomass feedstock 100 includes a moisture content from about 20 wt % to about 70 wt %. In some embodiments, the biomass feedstock 100 includes a moisture content from about 25 wt % to about 70 wt %. In some embodiments, the biomass feedstock 100 includes a moisture content from about 30 wt % to about 70 wt %. In some embodiments, the biomass feedstock 100 includes a moisture content from about 35 wt % to about 70 wt %. In some embodiments, the biomass feedstock 100 includes a moisture content from about 40 wt % to about 70 wt %. In some embodiments, the biomass feedstock 100 includes a moisture content from about 45 wt % to about 70 wt %. In some embodiments, the biomass feedstock 100 includes a moisture content from about 50 wt % to about 70 wt %. In some embodiments, the biomass feedstock 100 includes a moisture content from about 55 wt % to about 70 wt %. In some embodiments, the biomass feedstock 100 includes a moisture content from about 60 wt % to about 70 wt %. In some embodiments, the biomass feedstock 100 includes a moisture content from about 65 wt % to about 70 wt %. In some embodiments, the biomass feedstock 100 includes a moisture content from about 5 wt % to about 65 wt %. In some embodiments, the biomass feedstock 100 includes a moisture content from about 5 wt % to about 60 wt %. In some embodiments, the biomass feedstock 100 includes a moisture content from about 5 wt % to about 55 wt %. In some embodiments, the biomass feedstock 100 includes a moisture content from about 5 wt % to about 50 wt %. In some embodiments, the biomass feedstock 100 includes a moisture content from about 5 wt % to about 45 wt %. In some embodiments, the biomass feedstock 100 includes a moisture content from about 5 wt % to about 40 wt %. In some embodiments, the biomass feedstock 100 includes a moisture content from about 5 wt % to about 35 wt %. In some embodiments, the biomass feedstock 100 includes a moisture content from about 5 wt % to about 30 wt %. In some embodiments, the biomass feedstock 100 includes a moisture content from about 5 wt % to about 25 wt %. In some embodiments, the biomass feedstock 100 includes a moisture content from about 5 wt % to about 20 wt %. In some embodiments, the biomass feedstock 100 includes a moisture content from about 5 wt % to about 15 wt %. In some embodiments, the biomass feedstock 100 includes a moisture content from about 5 wt % to about 10 wt %. In some embodiments, the biomass feedstock 100 includes a moisture content from about 10 wt % to about 50 wt %. In some embodiments, the biomass feedstock 100 includes a moisture content from about 20 wt % to about 60 wt %. In some embodiments, the biomass feedstock 100 includes a moisture content from about 30 wt % to about 50 wt %. In some embodiments, the biomass feedstock 100 includes a moisture content from about 40 wt % to about 60 wt %.

In the illustrated embodiment of FIG. 4, the biomass feedstock 100 includes a C:N ratio of about 30:1. In some embodiments, the biomass feedstock 100 includes a C:N ratio ranging from about 20:1 to 40:1. In some embodiments, the biomass feedstock 100 includes a C:N ratio ranging from about 25:1 to 40:1. In some embodiments, the biomass feedstock 100 includes a C:N ratio ranging from about 30:1 to 40:1. In some embodiments, the biomass feedstock 100 includes a C:N ratio ranging from about 20:1 to 35:1. In some embodiments, the biomass feedstock 100 includes a C:N ratio ranging from about 20:1 to 30:1.

In some embodiments, the biomass feedstock 100 is pre-treated. In some embodiments, pre-treatment includes steam treatment, chemical treatment, biochemical treatment, and/or mechanical treatment, including any combinations thereof.

With continued reference to FIG. 4, in the illustrated embodiment, the initial gas composition 102 is air. In some embodiments, the initial gas composition 102 includes one or more of N₂, CO₂, and/or O₂. In some embodiments, the initial gas composition 102 includes one or more of air, steam, oxygen, and/or CO₂.

With continued reference to FIG. 4, the one or more additives 101 include water, microbial inoculants, purified enzymes, silicate minerals, carbonate minerals, acids, and/or bases.

With continued reference to FIG. 4, in some embodiments, incubation occurs at bioreactor pressures ranging from about 1 psia to about 100 psia. In some embodiments, incubation occurs at bioreactor pressures ranging from about 1 psia to about 75 psia. In some embodiments, incubation occurs at bioreactor pressures ranging from about 1 psia to about 50 psia. In some embodiments, incubation occurs at bioreactor pressures ranging from about 1 psia to about 25 psia. In some embodiments, incubation occurs at bioreactor pressures ranging from about 25 psia to about 100 psia. In some embodiments, incubation occurs at bioreactor pressures ranging from about 50 psia to about 100 psia. In some embodiments, incubation occurs at bioreactor pressures ranging from about 75 psia to about 100 psia. In some embodiments, incubation occurs at bioreactor pressures ranging from about 25 psia to about 75 psia.

In some embodiments, incubation occurs at temperatures ranging from about 30° C. to about 70° C. In some embodiments, incubation occurs at temperatures ranging from about 35° C. to about 70° C. In some embodiments, incubation occurs at temperatures ranging from about 40° C. to about 70° C. In some embodiments, incubation occurs at temperatures ranging from about 45° C. to about 70° C. In some embodiments, incubation occurs at temperatures ranging from about 50° C. to about 70° C. In some embodiments, incubation occurs at temperatures ranging from about 55° C. to about 70° C. In some embodiments, incubation occurs at temperatures ranging from about 60° C. to about 70° C. In some embodiments, incubation occurs at temperatures ranging from about 65° C. to about 70° C. In some embodiments, incubation occurs at temperatures ranging from about 30° C. to about 65° C. In some embodiments, incubation occurs at temperatures ranging from about 30° C. to about 60° C. In some embodiments, incubation occurs at temperatures ranging from about 30° C. to about 55° C. In some embodiments, incubation occurs at temperatures ranging from about 30° C. to about 50° C. In some embodiments, incubation occurs at temperatures ranging from about 30° C. to about 45° C. In some embodiments, incubation occurs at temperatures ranging from about 30° C. to about 40° C. In some embodiments, incubation occurs at temperatures ranging from about 30° C. to about 35° C. In some embodiments, incubation occurs at temperatures ranging from about 40° C. to about 60° C. In some embodiments, incubation occurs at temperatures ranging from about 50° C. to about 70° C. In some embodiments, incubation occurs at temperatures ranging from about 45° C. to about 55° C.

In some embodiments, incubation occurs at pH values ranging from about 3 to about 9. In some embodiments, incubation occurs at pH values ranging from about 4 to about 9. In some embodiments, incubation occurs at pH values ranging from about 5 to about 9. In some embodiments, incubation occurs at pH values ranging from about 6 to about 9. In some embodiments, incubation occurs at pH values ranging from about 7 to about 9. In some embodiments, incubation occurs at pH values ranging from about 8 to about 9. In some embodiments, incubation occurs at pH values ranging from about 3 to about 8. In some embodiments, incubation occurs at pH values ranging from about 3 to about 7. In some embodiments, incubation occurs at pH values ranging from about 3 to about 6. In some embodiments, incubation occurs at pH values ranging from about 3 to about 5. In some embodiments, incubation occurs at pH values ranging from about 3 to about 4. In some embodiments, incubation occurs at pH values ranging from about 4 to about 8. In some embodiments, incubation occurs at pH values ranging from about 5 to about 7.

With continued reference to FIG. 4, after incubating the biomass feedstock 100 and the initial gas composition 102, a compost composition 104 and an extracted gas composition 105 comprising CO₂ are obtained. In the illustrated embodiment, the compost composition 104 is used for soil regeneration. In the illustrated embodiment, the extracted gas composition 105 comprising CO₂ undergoes additional CO₂ capture. In some embodiments, additional CO₂ capture includes at least one of absorption, adsorption, and/or membrane separation. In the illustrated embodiment, after additional CO₂ capture, high purity CO₂ is produced. The high purity CO₂ can be utilized in other processes or can be geologically sequestered.

In some embodiments of a post-composting CO₂ capture system, the composting and CO₂ capture method is used with a continuous bioreactor. For example, biomass feedstock, including one or more additives, is input into the continuous bioreactor using a feeder. The continuous reactor can include a first chamber. The initial gas composition is input into the first chamber. In some embodiments, the initial gas composition is air. In some embodiments, the initial gas composition is one or more of N₂, CO₂, and/or O₂. The biomass feedstock and initial gas composition incubate in the first chamber for a predetermined incubating time, as described further herein. In some embodiments, the predetermined incubation is the same in each cycle. In other embodiments, the predetermined incubation time is different for one or more cycles. The predetermined incubating time provides incubation until the first chamber reaches a maintained gas composition. In some embodiments, the maintained gas composition includes one or more of O₂, N₂, and/or CO₂. In some embodiments, the maintained gas composition within the first chamber is 10% O₂, 10% CO₂, and 80% N₂.

In some embodiments, after the predetermined incubating time, the biomass feedstock flows into a second chamber. The initial gas composition is input into the second chamber. In some embodiments, the initial gas composition is air. In some embodiments, the initial gas composition is one or more of N₂, CO₂, and/or O₂. The biomass feedstock and initial gas composition incubate in the second chamber for the predetermined incubating time. The predetermined incubating time provides incubation until the second chamber reaches the maintained gas composition. In some embodiments, the maintained gas composition includes one or more of O₂, N₂, and/or CO₂. In some embodiments, the maintained gas composition within the second chamber is 5% O₂, 15% CO₂ and 80% N₂.

In some embodiments, after the predetermined incubating time, the biomass feedstock flows into a third chamber. The initial gas composition is input into the third chamber. In some embodiments, the initial gas composition is air. In some embodiments, the initial gas composition is one or more of N₂, CO₂, and/or O₂. The biomass feedstock and initial gas composition incubate in the third chamber for the predetermined incubating time. The predetermined incubating time provides incubation until the third chamber reaches the maintained gas composition. In some embodiments, the maintained gas composition includes one or more of O₂, N₂, and/or CO₂. In some embodiments, the maintained gas composition within the third chamber 406 is 1% O₂, 19% CO₂ and 80% N₂.

After the predetermined incubating time in the first, second, and/or third chamber, the compost composition and the extracted gas composition are obtained. The continuous reactor provides continuous incubation that can be controlled using gravity to aid in flowing the biomass feedstock through the continuous bioreactor, and one or more valves to control bioreactor pressures and the maintained gas compositions. In other words, the continuous bioreactor provides a continuous composting and CO₂ capture process without the added labor and energy costs of the batch bioreactor and the semi-batch bioreactor.

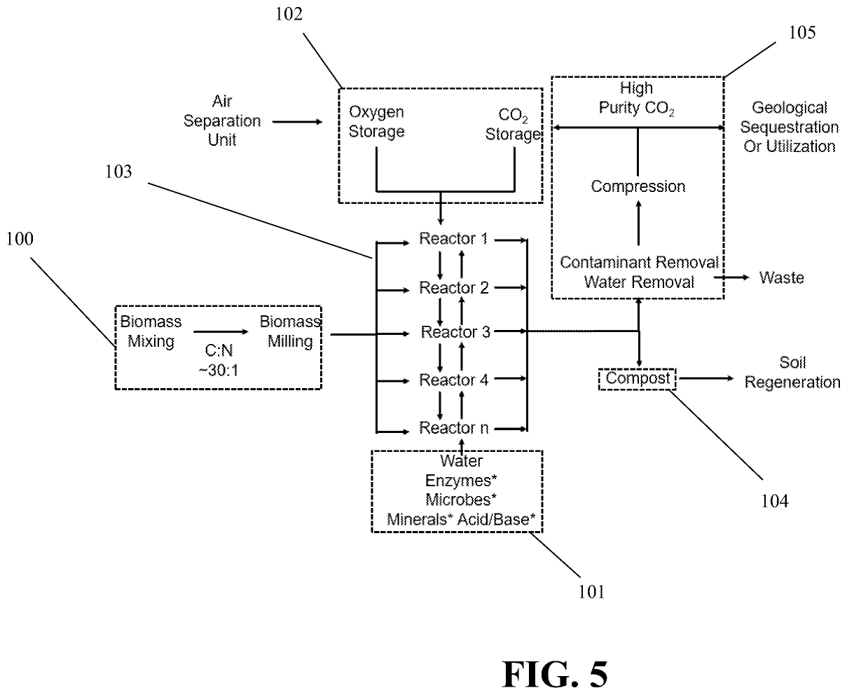

FIG. 5 illustrates a general process flow diagram of pre-composting CO₂ capture, where the composting and CO₂ capture method is used with one or more batch or semi-batch bioreactors 103. With reference to FIG. 5, a biomass feedstock 100, one or more additives 101, and an initial gas composition 102 are input into the one or more bioreactors 103.

With continued reference to FIG. 5, the biomass feedstock 100 includes one or more of organic biomass feedstock, food waste, animal waste, human waste, agricultural waste, forestry waste, industrial waste, and/or lignocellulosic feedstock. In some embodiments, the biomass feedstock 100 includes one or more of lignocellulose, starches, sugars, organic acids, polysaccharides, peptides, polypeptides, proteins, and/or lipids.

In some embodiments, the biomass feedstock 100 includes particle sizes that range from about 1 mm to about 10 m. In some embodiments, the biomass feedstock 100 includes particle sizes that range from about 10 mm to about 10 m. In some embodiments, the biomass feedstock 100 includes particle sizes that range from about 100 mm to about 10 m. In some embodiments, the biomass feedstock 100 includes particle sizes that range from about 1000 mm to about 10 m. In some embodiments, the biomass feedstock 100 includes particle sizes that range from about 1 mm to about 1 m. In some embodiments, the biomass feedstock 100 includes particle sizes that range from about 10 mm to about 10 cm. In some embodiments, the biomass feedstock 100 includes particle sizes that range from about 100 mm to about 100 cm.

In some embodiments, the biomass feedstock 100 includes a moisture content from about 5 wt % to about 70 wt %. In some embodiments, the biomass feedstock 100 includes a moisture content from about 10 wt % to about 70 wt %. In some embodiments, the biomass feedstock 100 includes a moisture content from about 15 wt % to about 70 wt %. In some embodiments, the biomass feedstock 100 includes a moisture content from about 20 wt % to about 70 wt %. In some embodiments, the biomass feedstock 100 includes a moisture content from about 25 wt % to about 70 wt %. In some embodiments, the biomass feedstock 100 includes a moisture content from about 30 wt % to about 70 wt %. In some embodiments, the biomass feedstock 100 includes a moisture content from about 35 wt % to about 70 wt %. In some embodiments, the biomass feedstock 100 includes a moisture content from about 40 wt % to about 70 wt %. In some embodiments, the biomass feedstock 100 includes a moisture content from about 45 wt % to about 70 wt %. In some embodiments, the biomass feedstock 100 includes a moisture content from about 50 wt % to about 70 wt %. In some embodiments, the biomass feedstock 100 includes a moisture content from about 55 wt % to about 70 wt %. In some embodiments, the biomass feedstock 100 includes a moisture content from about 60 wt % to about 70 wt %. In some embodiments, the biomass feedstock 100 includes a moisture content from about 65 wt % to about 70 wt %. In some embodiments, the biomass feedstock 100 includes a moisture content from about 5 wt % to about 65 wt %. In some embodiments, the biomass feedstock 100 includes a moisture content from about 5 wt % to about 60 wt %. In some embodiments, the biomass feedstock 100 includes a moisture content from about 5 wt % to about 55 wt %. In some embodiments, the biomass feedstock 100 includes a moisture content from about 5 wt % to about 50 wt %. In some embodiments, the biomass feedstock 100 includes a moisture content from about 5 wt % to about 45 wt %. In some embodiments, the biomass feedstock 100 includes a moisture content from about 5 wt % to about 40 wt %. In some embodiments, the biomass feedstock 100 includes a moisture content from about 5 wt % to about 35 wt %. In some embodiments, the biomass feedstock 100 includes a moisture content from about 5 wt % to about 30 wt %. In some embodiments, the biomass feedstock 100 includes a moisture content from about 5 wt % to about 25 wt %. In some embodiments, the biomass feedstock 100 includes a moisture content from about 5 wt % to about 20 wt %. In some embodiments, the biomass feedstock 100 includes a moisture content from about 5 wt % to about 15 wt %. In some embodiments, the biomass feedstock 100 includes a moisture content from about 5 wt % to about 10 wt %. In some embodiments, the biomass feedstock 100 includes a moisture content from about 10 wt % to about 50 wt %. In some embodiments, the biomass feedstock 100 includes a moisture content from about 20 wt % to about 60 wt %. In some embodiments, the biomass feedstock 100 includes a moisture content from about 30 wt % to about 50 wt %. In some embodiments, the biomass feedstock 100 includes a moisture content from about 40 wt % to about 60 wt %.

In the illustrated embodiment of FIG. 1, the biomass feedstock 100 includes a C:N ratio of about 30:1. In some embodiments, the biomass feedstock 100 includes a C:N ratio ranging from about 20:1 to 40:1. In some embodiments, the biomass feedstock 100 includes a C:N ratio ranging from about 25:1 to 40:1. In some embodiments, the biomass feedstock 100 includes a C:N ratio ranging from about 30:1 to 40:1. In some embodiments, the biomass feedstock 100 includes a C:N ratio ranging from about 20:1 to 35:1. In some embodiments, the biomass feedstock 100 includes a C:N ratio ranging from about 20:1 to 30:1.

In some embodiments, the biomass feedstock 100 is pre-treated. In some embodiments, pre-treatment includes steam treatment, chemical treatment, biochemical treatment, and/or mechanical treatment, including any combinations thereof.

With continued reference to FIG. 5, in the illustrated embodiment, the initial gas composition 102 is high purity O₂ and/or high purity CO₂. In some embodiments, the one or more additives 101 include water, microbial inoculants, purified enzymes, silicate minerals, carbonate minerals, acids, and/or bases.

With continued reference to FIG. 5, in some embodiments, incubation occurs at bioreactor pressures ranging from about 1 psia to about 100 psia. In some embodiments, incubation occurs at bioreactor pressures ranging from about 1 psia to about 75 psia. In some embodiments, incubation occurs at bioreactor pressures ranging from about 1 psia to about 50psia. In some embodiments, incubation occurs at bioreactor pressures ranging from about 1 psia to about 25 psia. In some embodiments, incubation occurs at bioreactor pressures ranging from about 25 psia to about 100 psia. In some embodiments, incubation occurs at bioreactor pressures ranging from about 50 psia to about 100 psia. In some embodiments, incubation occurs at bioreactor pressures ranging from about 75 psia to about 100 psia. In some embodiments, incubation occurs at bioreactor pressures ranging from about 25 psia to about 75 psia.

In some embodiments, incubation occurs at temperatures ranging from about 30° C. to about 70° C. In some embodiments, incubation occurs at temperatures ranging from about 35° C. to about 70° C. In some embodiments, incubation occurs at temperatures ranging from about 40° C. to about 70° C. In some embodiments, incubation occurs at temperatures ranging from about 45° C. to about 70° C. In some embodiments, incubation occurs at temperatures ranging from about 50° C. to about 70° C. In some embodiments, incubation occurs at temperatures ranging from about 55° C. to about 70° C. In some embodiments, incubation occurs at temperatures ranging from about 60° C. to about 70° C. In some embodiments, incubation occurs at temperatures ranging from about 65° C. to about 70° C. In some embodiments, incubation occurs at temperatures ranging from about 30° C. to about 65° C. In some embodiments, incubation occurs at temperatures ranging from about 30° C. to about 60° C. In some embodiments, incubation occurs at temperatures ranging from about 30° C. to about 55° C. In some embodiments, incubation occurs at temperatures ranging from about 30° C. to about 50° C. In some embodiments, incubation occurs at temperatures ranging from about 30° C. to about 45° C. In some embodiments, incubation occurs at temperatures ranging from about 30° C. to about 40° C. In some embodiments, incubation occurs at temperatures ranging from about 30° C. to about 35° C. In some embodiments, incubation occurs at temperatures ranging from about 40° C. to about 60° C. In some embodiments, incubation occurs at temperatures ranging from about 50° C. to about 70° C. In some embodiments, incubation occurs at temperatures ranging from about 45° C. to about 55° C.

In some embodiments, incubation occurs at pH values ranging from about 3 to about 9. In some embodiments, incubation occurs at pH values ranging from about 4 to about 9. In some embodiments, incubation occurs at pH values ranging from about 5 to about 9. In some embodiments, incubation occurs at pH values ranging from about 6 to about 9. In some embodiments, incubation occurs at pH values ranging from about 7 to about 9. In some embodiments, incubation occurs at pH values ranging from about 8 to about 9. In some embodiments, incubation occurs at pH values ranging from about 3 to about 8. In some embodiments, incubation occurs at pH values ranging from about 3 to about 7. In some embodiments, incubation occurs at pH values ranging from about 3 to about 6. In some embodiments, incubation occurs at pH values ranging from about 3 to about 5. In some embodiments, incubation occurs at pH values ranging from about 3 to about 4. In some embodiments, incubation occurs at pH values ranging from about 4 to about 8. In some embodiments, incubation occurs at pH values ranging from about 5 to about 7.

With continued reference to FIG. 5, after incubating the biomass feedstock 100 and the initial gas composition 102, a compost composition 104 and an extracted gas composition 105 comprising high purity CO₂ are obtained. In the illustrated embodiment, the compost composition 104 is used for soil regeneration. In the illustrated embodiment, the extracted gas composition 105 comprising high purity CO₂ is captured directly from the one or more bioreactors 103. The high purity CO₂ can be utilized in other processes or geologically sequestered. In some embodiments, the high purity CO₂ can be utilized in the initial gas composition 102 for pre-composting CO₂ capture.

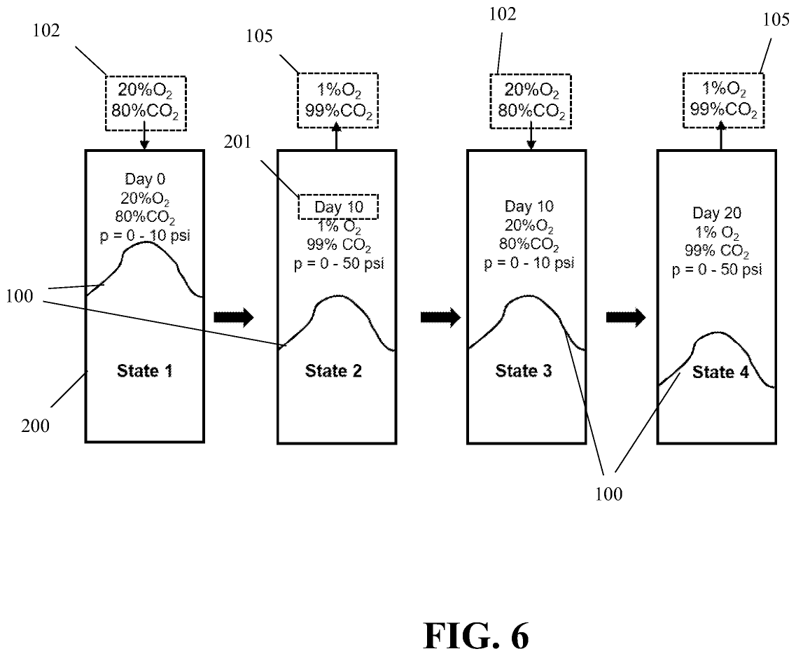

FIG. 6 illustrates an example of pre-composting CO₂ capture, where the composting and CO₂ capture method is used with a batch bioreactor 200. With reference to FIG. 6, pre-composting CO₂ capture using the batch bioreactor 200 is illustrated in four states. State 1 illustrates the start of pre-composting CO₂ capture, where the biomass feedstock 100, including the one or more additives 101, is input into the batch bioreactor 200 with the initial gas composition 102. In the illustrated embodiment, the initial gas composition 102 is high purity O₂and high purity CO₂. In some embodiments, the batch bioreactor 200 includes a static vessel, screw reactor, and/or rotating drum.

With continued reference to FIG. 6, State 2 illustrates pre-composting CO₂ capture after a predetermined incubating time 201. In the illustrated embodiment, the predetermined incubating time 201 is about 10 days, though other predetermined incubation times can be used, as described further herein. In some embodiments, the predetermined incubating time 201 ranges from about 1 day to about 100 days. In some embodiments, the predetermined incubating time 201 ranges from about 1 day to about 75 days. In some embodiments, the predetermined incubating time 201 ranges from about 1 day to about 50 days. In some embodiments, the predetermined incubating time 201 ranges from about 1 day to about 25 days. In some embodiments, the predetermined incubating time 201 ranges from about 1 day to about 10 days. In some embodiments, the predetermined incubating time 201 ranges from about 10 days to about 100 days. In some embodiments, the predetermined incubating time 201 ranges from about 25days to about 100 days. In some embodiments, the predetermined incubating time 201 ranges from about 50 days to about 100 days. In some embodiments, the predetermined incubating time 201 ranges from about 75 days to about 100 days.

In some embodiments, incubation occurs at pressures ranging from about 1 psia to about 100 psia within the batch bioreactor reactor 200. In some embodiments, incubation occurs at bioreactor pressures ranging from about 1 psia to about 75 psia. In some embodiments, incubation occurs at bioreactor pressures ranging from about 1 psia to about 50 psia. In some embodiments, incubation occurs at bioreactor pressures ranging from about 1 psia to about 25 psia. In some embodiments, incubation occurs at bioreactor pressures ranging from about 25 psia to about 100 psia. In some embodiments, incubation occurs at bioreactor pressures ranging from about 50 psia to about 100 psia. In some embodiments, incubation occurs at bioreactor pressures ranging from about 75 psia to about 100 psia. In some embodiments, incubation occurs at bioreactor pressures ranging from about 25 psia to about 75 psia.

In the illustrated embodiment of FIG. 6, the batch bioreactor 200 (in State 2) increases in pressure compared to State 1. In the illustrated embodiment, the batch bioreactor 200 includes at least one vacuum pump. The extracted gas composition 105 is pumped out of the batch bioreactor 200. In the illustrated embodiment, the extracted gas composition 105 includes O₂ and CO₂.

With continued reference to FIG. 6, State 3 illustrates pre-composting CO₂ capture after the initial gas composition 102 is input into the reactor after incubating for the predetermined incubating time 201 and extraction of the extracted gas composition 105. In the illustrated embodiment, the biomass feedstock 100 remains in the batch bioreactor 200. In the illustrated embodiment, the batch bioreactor 200 (in State 3) decreases in pressure compared to State 2.

With continued reference to FIG. 6, State 4 illustrates pre-composting CO₂ capture after the predetermined incubating time 201 elapses again. In some embodiments, the predetermined incubation is the same in each cycle. In other embodiments, the predetermined incubation time is different for one or more cycles. In the illustrated embodiment, the predetermined incubating time 201 is 10 days, though other predetermined incubation times can be used, as described further herein. In the illustrated embodiment, at State 4, pre-composting CO₂ capture has occurred for a total of 20 days. The extracted gas composition 105 is pumped out of the batch bioreactor 200. In the illustrated embodiment, the extracted gas composition 105 is high purity CO₂ State 1 to State 4 illustrates an example pre-composting CO₂ capture cycle that can be repeated until all available carbon within the biomass feedstock 100 has been converted to CO₂ during incubation in the batch bioreactor 200. Once all available carbon within the biomass feedstock 100 has been converted to CO₂ during incubation, the compost composition 104 is extracted from the batch bioreactor 200.

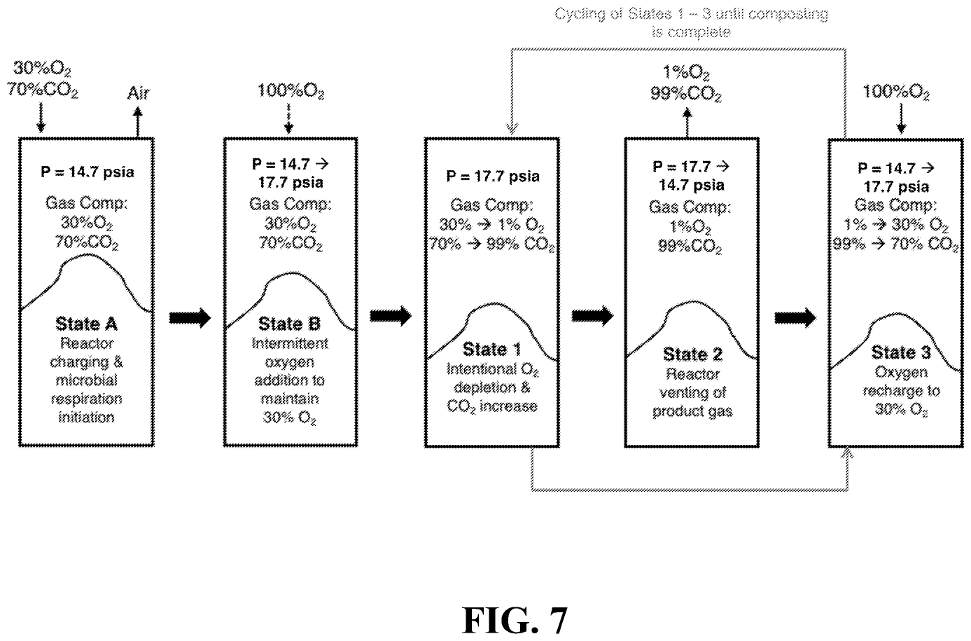

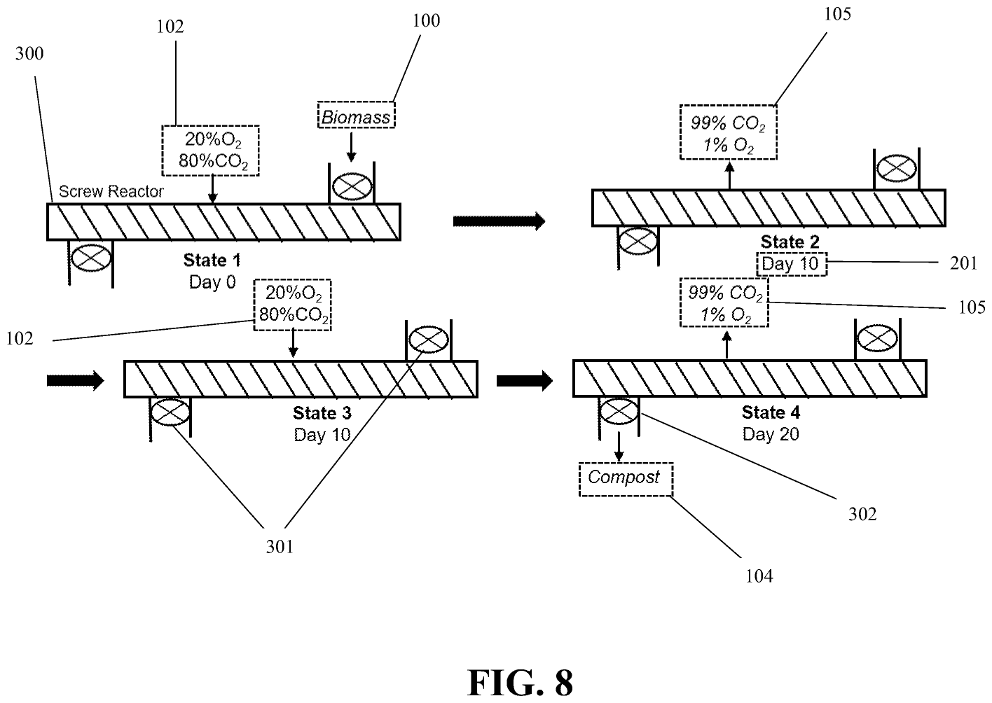

In some embodiments, the bioreactors/systems of the present disclosure include various processing steps to continuously or semi-continuously produce high purity biogenic CO₂ for capture from composting of biomass materials (FIG. 7). These methods can include using high purity O₂ over a certain number of cycles to produce and extract high concentrations of CO₂. In some embodiments, a pre-composting CO₂ capture method is used with a semi-batch bioreactor 300 (FIG. 8). With reference to FIG. 8, pre-composting CO₂ capture using the semi-batch bioreactor 300 is illustrated in four states. State 1 illustrates the start of pre-composting CO₂ capture, where the biomass feedstock 100, including the one or more additives 101, is input into the semi-batch bioreactor 300 with the initial gas composition 102. In the illustrated embodiment, the initial gas composition 102 is O₂ and CO₂. In the illustrated embodiment, the semi-batch bioreactor 300 includes a screw reactor. In some embodiments, the semi-batch bioreactor 300 includes a static vessel or rotating drum. In the illustrated embodiment, the semi-batch bioreactor 300 includes one or more valves 301, specifically knife gate valves. In some embodiments, the semi-batch bioreactor 300 includes at least one knife gate valve and/or ball valve.

With continued reference to FIG. 8, State 2 illustrates pre-composting CO₂ capture after a predetermined incubating time 201. In the illustrated embodiment, the predetermined incubating time 201 is about 10 days, though other predetermined incubation times can be used, as described further herein. In some embodiments, the predetermined incubating time 201 ranges from about 1 day to about 100 days. In some embodiments, the predetermined incubating time 201 ranges from about 1 day to about 75 days. In some embodiments, the predetermined incubating time 201 ranges from about 1 day to about 50 days. In some embodiments, the predetermined incubating time 201 ranges from about 1 day to about 25 days. In some embodiments, the predetermined incubating time 201 ranges from about 1 day to about 10 days. In some embodiments, the predetermined incubating time 201 ranges from about 10 days to about 100 days. In some embodiments, the predetermined incubating time 201 ranges from about 25 days to about 100 days. In some embodiments, the predetermined incubating time 201 ranges from about 50 days to about 100 days. In some embodiments, the predetermined incubating time 201 ranges from about 75 days to about 100 days.

In the illustrated embodiment, the semi-batch bioreactor 300 includes at least one vacuum pump. The extracted gas composition 105 is pumped out of the semi-batch bioreactor 300. In the illustrated embodiment, the extracted gas composition 105 includes high purity CO₂.

With continued reference to FIG. 8, State 3 illustrates pre-composting CO₂ capture after the initial gas composition 102 is input into the reactor after incubating for the predetermined incubating time 201 and extraction of the extracted gas composition 105. In the illustrated embodiment, the biomass feedstock 100 remains in the semi-batch bioreactor 300.

With continued reference to FIG. 8, State 4 illustrates pre-composting CO₂ capture after the predetermined incubating time 201 elapses again. In some embodiments, the predetermined incubation is the same in each cycle. In other embodiments, the predetermined incubation time is different for one or more cycles. In the illustrated embodiment, the predetermined incubating time 201 is about 10 days. In some embodiments, the predetermined incubating time 201 ranges from about 1 day to about 100 days. In some embodiments, the predetermined incubating time 201 ranges from about 1 day to about 75 days. In some embodiments, the predetermined incubating time 201 ranges from about 1 day to about 50 days. In some embodiments, the predetermined incubating time 201 ranges from about 1 day to about 25 days. In some embodiments, the predetermined incubating time 201 ranges from about 1 day to about 10 days. In some embodiments, the predetermined incubating time 201 ranges from about 10 days to about 100 days. In some embodiments, the predetermined incubating time 201 ranges from about 25 days to about 100 days. In some embodiments, the predetermined incubating time 201 ranges from about 50 days to about 100 days. In some embodiments, the predetermined incubating time 201 ranges from about 75 days to about 100 days.

In the illustrated embodiment, at State 4, pre-composting CO₂ capture has occurred for a total of 20 days. The extracted gas composition 105 is pumped out of the semi-batch bioreactor 300. In the illustrated embodiment, the extracted gas composition 105 includes high purity CO₂. State 1 to State 4 illustrates an example pre-composting CO₂ capture cycle that can be repeated until all available carbon within the biomass feedstock 100 has been converted to CO₂ during incubation in the semi-batch bioreactor 300. Once all available carbon within the biomass feedstock 100 has been converted to CO₂ during incubation, the compost composition 104 is extracted from the semi-batch bioreactor 300. In the illustrated embodiment, the compost composition 104 is extracted through one of the knife-gate valves 302.

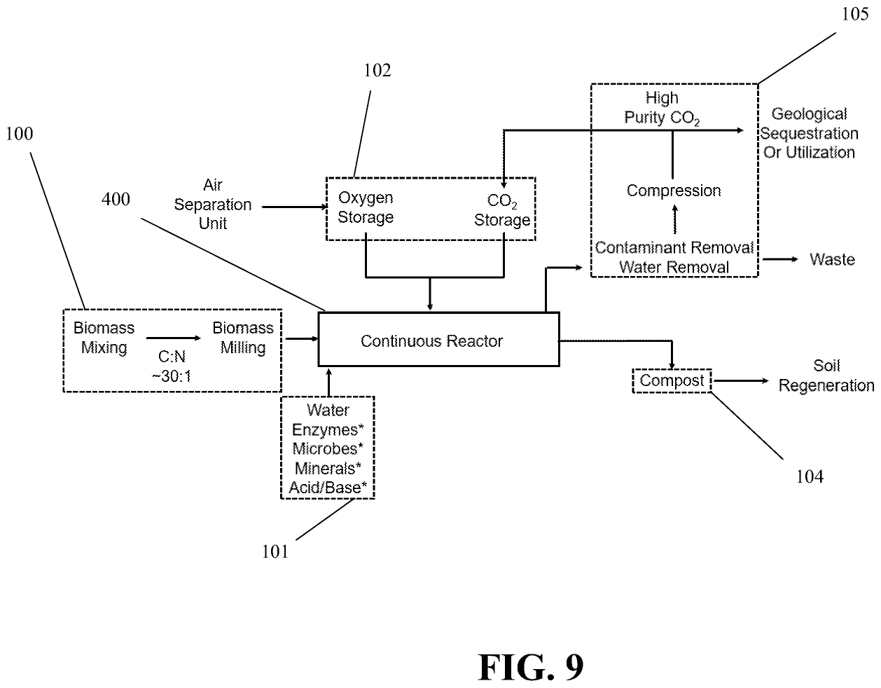

FIG. 9 illustrates a general process flow diagram of pre-composting CO₂ capture, where the composting and CO₂ capture method is used with a continuous bioreactor. With reference to FIG. 9, a biomass feedstock 100, one or more additives 101, and an initial gas composition 102 are input into a continuous bioreactor 400.

With continued reference to FIG. 9, the biomass feedstock 100 includes one or more of organic biomass feedstock, food waste, animal waste, human waste, agricultural waste, forestry waste, industrial waste, and/or lignocellulosic feedstock. In some embodiments, the biomass feedstock 100 includes one or more of lignocellulose, starches, sugars, organic acids, polysaccharides, peptides, polypeptides, proteins, and/or lipids.

In some embodiments, the biomass feedstock 100 includes particle sizes that range from about 1 mm to about 10 m. In some embodiments, the biomass feedstock 100 includes particle sizes that range from about 10 mm to about 10 m. In some embodiments, the biomass feedstock 100 includes particle sizes that range from about 100 mm to about 10 m. In some embodiments, the biomass feedstock 100 includes particle sizes that range from about 1000 mm to about 10 m. In some embodiments, the biomass feedstock 100 includes particle sizes that range from about 1 mm to about 1 m. In some embodiments, the biomass feedstock 100 includes particle sizes that range from about 10 mm to about 10 cm. In some embodiments, the biomass feedstock 100 includes particle sizes that range from about 100 mm to about 100 cm.

In some embodiments, the biomass feedstock 100 includes a moisture content from about 5 wt % to about 70 wt %. In some embodiments, the biomass feedstock 100 includes a moisture content from about 10 wt % to about 70 wt %. In some embodiments, the biomass feedstock 100 includes a moisture content from about 15 wt % to about 70 wt %. In some embodiments, the biomass feedstock 100 includes a moisture content from about 20 wt % to about 70 wt %. In some embodiments, the biomass feedstock 100 includes a moisture content from about 25 wt % to about 70 wt %. In some embodiments, the biomass feedstock 100 includes a moisture content from about 30 wt % to about 70 wt %. In some embodiments, the biomass feedstock 100 includes a moisture content from about 35 wt % to about 70 wt %. In some embodiments, the biomass feedstock 100 includes a moisture content from about 40 wt % to about 70 wt %. In some embodiments, the biomass feedstock 100 includes a moisture content from about 45 wt % to about 70 wt %. In some embodiments, the biomass feedstock 100 includes a moisture content from about 50 wt % to about 70 wt %. In some embodiments, the biomass feedstock 100 includes a moisture content from about 55 wt % to about 70 wt %. In some embodiments, the biomass feedstock 100 includes a moisture content from about 60 wt % to about 70 wt %. In some embodiments, the biomass feedstock 100 includes a moisture content from about 65 wt % to about 70 wt %. In some embodiments, the biomass feedstock 100 includes a moisture content from about 5 wt % to about 65 wt %. In some embodiments, the biomass feedstock 100 includes a moisture content from about 5 wt % to about 60 wt %. In some embodiments, the biomass feedstock 100 includes a moisture content from about 5 wt % to about 55 wt %. In some embodiments, the biomass feedstock 100 includes a moisture content from about 5 wt % to about 50 wt %. In some embodiments, the biomass feedstock 100 includes a moisture content from about 5 wt % to about 45 wt %. In some embodiments, the biomass feedstock 100 includes a moisture content from about 5 wt % to about 40 wt %. In some embodiments, the biomass feedstock 100 includes a moisture content from about 5 wt % to about 35 wt %. In some embodiments, the biomass feedstock 100 includes a moisture content from about 5 wt % to about 30 wt %. In some embodiments, the biomass feedstock 100 includes a moisture content from about 5 wt % to about 25 wt %. In some embodiments, the biomass feedstock 100 includes a moisture content from about 5 wt % to about 20 wt %. In some embodiments, the biomass feedstock 100 includes a moisture content from about 5 wt % to about 15 wt %. In some embodiments, the biomass feedstock 100 includes a moisture content from about 5 wt % to about 10 wt %. In some embodiments, the biomass feedstock 100 includes a moisture content from about 10 wt % to about 50 wt %. In some embodiments, the biomass feedstock 100 includes a moisture content from about 20 wt % to about 60 wt %. In some embodiments, the biomass feedstock 100 includes a moisture content from about 30 wt % to about 50 wt %. In some embodiments, the biomass feedstock 100 includes a moisture content from about 40 wt % to about 60 wt %.

In the illustrated embodiment of FIG. 1, the biomass feedstock 100 includes a C:N ratio of about 30:1. In some embodiments, the biomass feedstock 100 includes a C:N ratio ranging from about 20:1 to 40:1. In some embodiments, the biomass feedstock 100 includes a C:N ratio ranging from about 25:1 to 40:1. In some embodiments, the biomass feedstock 100 includes a C:N ratio ranging from about 30:1 to 40:1. In some embodiments, the biomass feedstock 100 includes a C:N ratio ranging from about 20:1 to 35:1. In some embodiments, the biomass feedstock 100 includes a C:N ratio ranging from about 20:1 to 30:1.

In some embodiments, the biomass feedstock 100 is pre-treated. In some embodiments, pre-treatment includes steam treatment, chemical treatment, biochemical treatment, and/or mechanical treatment, including any combinations thereof.

With continued reference to FIG. 9, in the illustrated embodiment, the initial gas composition 102 is O₂ and/or CO₂. In some embodiments, the one or more additives 101 include water, microbial inoculants, purified enzymes, silicate minerals, carbonate minerals, acids, and/or bases.

With continued reference to FIG. 9, in some embodiments, incubation occurs at bioreactor pressures ranging from about 1 psia to about 100 psia. In some embodiments, incubation occurs at bioreactor pressures ranging from about 1 psia to about 75 psia. In some embodiments, incubation occurs at bioreactor pressures ranging from about 1 psia to about 50 psia. In some embodiments, incubation occurs at bioreactor pressures ranging from about 1 psia to about 25 psia. In some embodiments, incubation occurs at bioreactor pressures ranging from about 25 psia to about 100 psia. In some embodiments, incubation occurs at bioreactor pressures ranging from about 50 psia to about 100 psia. In some embodiments, incubation occurs at bioreactor pressures ranging from about 75 psia to about 100 psia. In some embodiments, incubation occurs at bioreactor pressures ranging from about 25 psia to about 75 psia.

In some embodiments, incubation occurs at temperatures ranging from about 30° C. to about 70° C. In some embodiments, incubation occurs at temperatures ranging from about 35° C. to about 70° C. In some embodiments, incubation occurs at temperatures ranging from about 40° C. to about 70° C. In some embodiments, incubation occurs at temperatures ranging from about 45° C. to about 70° C. In some embodiments, incubation occurs at temperatures ranging from about 50° C. to about 70° C. In some embodiments, incubation occurs at temperatures ranging from about 55° C. to about 70° C. In some embodiments, incubation occurs at temperatures ranging from about 60° C. to about 70° C. In some embodiments, incubation occurs at temperatures ranging from about 65° C. to about 70° C. In some embodiments, incubation occurs at temperatures ranging from about 30° C. to about 65° C. In some embodiments, incubation occurs at temperatures ranging from about 30° C. to about 60° C. In some embodiments, incubation occurs at temperatures ranging from about 30° C. to about 55° C. In some embodiments, incubation occurs at temperatures ranging from about 30° C. to about 50° C. In some embodiments, incubation occurs at temperatures ranging from about 30° C. to about 45° C. In some embodiments, incubation occurs at temperatures ranging from about 30° C. to about 40° C. In some embodiments, incubation occurs at temperatures ranging from about 30° C. to about 35° C. In some embodiments, incubation occurs at temperatures ranging from about 40° C. to about 60° C. In some embodiments, incubation occurs at temperatures ranging from about 50° C. to about 70° C. In some embodiments, incubation occurs at temperatures ranging from about 45° C. to about 55° C.

In some embodiments, incubation occurs at pH values ranging from about 3 to about 9. In some embodiments, incubation occurs at pH values ranging from about 4 to about 9. In some embodiments, incubation occurs at pH values ranging from about 5 to about 9. In some embodiments, incubation occurs at pH values ranging from about 6 to about 9. In some embodiments, incubation occurs at pH values ranging from about 7 to about 9. In some embodiments, incubation occurs at pH values ranging from about 8 to about 9. In some embodiments, incubation occurs at pH values ranging from about 3 to about 8. In some embodiments, incubation occurs at pH values ranging from about 3 to about 7. In some embodiments, incubation occurs at pH values ranging from about 3 to about 6. In some embodiments, incubation occurs at pH values ranging from about 3 to about 5. In some embodiments, incubation occurs at pH values ranging from about 3 to about 4. In some embodiments, incubation occurs at pH values ranging from about 4 to about 8. In some embodiments, incubation occurs at pH values ranging from about 5 to about 7.

With continued reference to FIG. 9, after incubating the biomass feedstock 100 and the initial gas composition 102, a compost composition 104 and an extracted gas composition 105 comprising high purity CO₂ are obtained. In the illustrated embodiment, the compost composition 104 is used for soil regeneration. In the illustrated embodiment, the extracted gas composition 105 comprising high purity CO₂ is captured directly from the one or more bioreactors 103. The high purity CO₂ can be utilized in other processes or geologically sequestered. In some embodiments, the high purity CO₂ can be utilized in the initial gas composition 102 for pre-composting CO₂ capture.

In some embodiments of a pre-composting CO₂ capture system, the composting and CO₂ capture method is used with a continuous bioreactor. For example, biomass feedstock, including the one or more additives, is input into the continuous bioreactor using a feeder. The continuous reactor can include a first chamber. The initial gas composition is input into the first chamber. In some embodiments, the initial gas composition is air. In some embodiments, the initial gas composition is one or more of N₂, CO₂, and/or O₂. The biomass feedstock and initial gas composition incubate in the first chamber for a predetermined incubating time, as described further herein. In some embodiments, the predetermined incubation is the same in each cycle. In other embodiments, the predetermined incubation time is different for one or more cycles. The predetermined incubating time provides incubation until the first chamber reaches a maintained gas composition. In some embodiments, the maintained gas composition includes one or more of O₂, N₂, and/or CO₂. In some embodiments, the maintained gas composition within the first chamber is 10% O₂, 10% CO₂, and 80% N₂.

In some embodiments, after the predetermined incubating time, the biomass feedstock flows into a second chamber. The initial gas composition is input into the second chamber. In some embodiments, the initial gas composition is air. In some embodiments, the initial gas composition is one or more of N₂, CO₂, and/or O₂. The biomass feedstock and initial gas composition incubate in the second chamber for the predetermined incubating time. The predetermined incubating time provides incubation until the second chamber reaches the maintained gas composition. In some embodiments, the maintained gas composition includes one or more of O₂, N₂, and/or CO₂. In some embodiments, the maintained gas composition within the second chamber is 5% O₂, 15% CO₂ and 80% N₂.

In some embodiments, after the predetermined incubating time, the biomass feedstock flows into a third chamber. The initial gas composition is input into the third chamber. In some embodiments, the initial gas composition is air. In some embodiments, the initial gas composition is one or more of N₂, CO₂, and/or O₂. The biomass feedstock and initial gas composition incubate in the third chamber for the predetermined incubating time. The predetermined incubating time provides incubation until the third chamber reaches the maintained gas composition. In some embodiments, the maintained gas composition includes one or more of O₂, N₂, and/or CO₂. In some embodiments, the maintained gas composition within the third chamber 406 is 1% O₂, 19% CO₂ and 80% N₂.

After the predetermined incubating time in the first, second, and/or third chamber, the compost composition and the extracted gas composition are obtained. The continuous reactor provides continuous incubation that can be controlled using gravity to aid in flowing the biomass feedstock through the continuous bioreactor, and one or more valves to control bioreactor pressures and the maintained gas compositions. In other words, the continuous bioreactor provides a continuous composting and CO₂ capture process without the added labor and energy costs of the batch bioreactor and the semi-batch bioreactor.

With reference to FIG. 1, FIG. 4, FIG. 5, and FIG. 9, in alternate embodiments, the composting and CO₂ capture methods include heat recovery. In other words, since the composting and CO₂ capture methods are exothermic, heat is recovered. In some alternate embodiments, heat recovery is used in other processes.

In accordance with the above embodiments, the present disclosure also provides a bioreactor for performing the methods of composting and capturing CO₂ as described herein. In accordance with these embodiments, the bioreactor is configured to perform batch, semi-batch, or continuous composting and CO₂ capture. The bioreactor is also configured to perform pre-composing and post-composting CO₂ capture, as described further herein. In some embodiments, the bioreactor comprises at least one vacuum pump. In some embodiments, the bioreactor comprises one or more valves. In some embodiments, the bioreactor comprises at least one knife gate valve and/or at least one ball valve. In some embodiments, the bioreactor comprises a static vessel, a screw reactor, and/or a rotating drum. In some embodiments, the bioreactor comprises a biomass plug and a back pressure damper configured to control pressure (e.g., gas pressure).

In accordance with the above embodiments, the present disclosure also provides systems for performing the methods of composting and capturing CO₂ as described herein. In accordance with these embodiments, the system is configured to perform batch, semi-batch, or continuous composting and CO₂ capture. The system is also configured to perform pre-composing and post-composting CO₂ capture, as described further herein. In some embodiments, the systems of the present disclose include a plurality of bioreactors, as described further above, and any associated hardware and software components necessary for carrying out the various aspects of the methods of composting and capturing CO₂ described herein.

Referring to FIGS. 10 and 11, experiments were conducted to assess the efficacy of the bioreactors and bioreactor systems for performing the methods of composting and capturing CO₂ as described herein. FIG. 10 includes representative data of CO₂ and O₂ concentrations (vol %) in a bioreactor system that employs post-composting CO₂ capture. FIG. 11 includes representative data of CO₂ and O₂ concentrations (vol %) in a bioreactor system that employs pre-composting CO₂ capture.

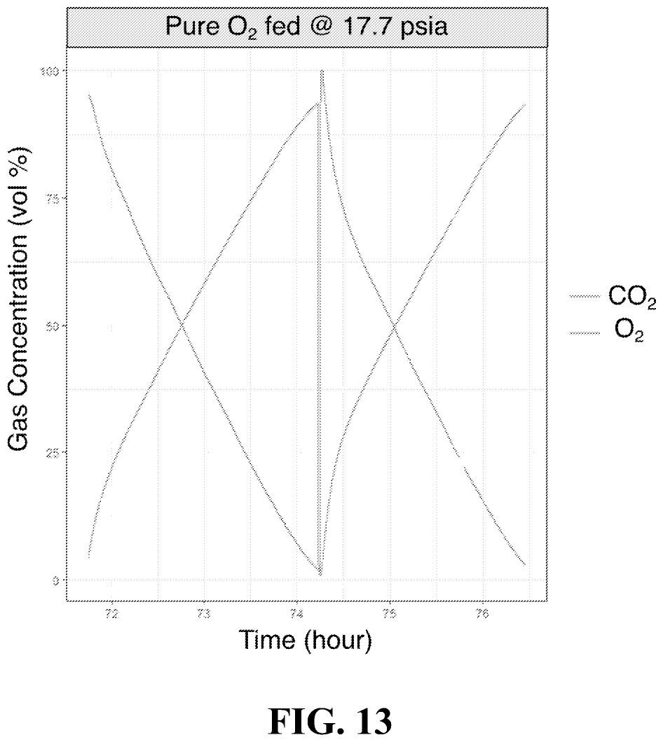

Referring to FIGS. 12 and 13, experiments were conducted to assess the efficacy of the bioreactors and bioreactor systems for performing the methods of composting and capturing CO₂ as described herein. FIG. 12 includes representative bioreactor gas composition data demonstrating the process of generating high purity biogenic CO₂ via pre-composting at different pressures (plots on left) and post-composting at different pressures (plots on right). FIG. 13 includes representative bioreactor gas composition data demonstrating the process of generating high purity biogenic CO₂ via pre-composting under pressurized conditions. In this experiment, a pure O₂ feed was used at 17.7 psia.

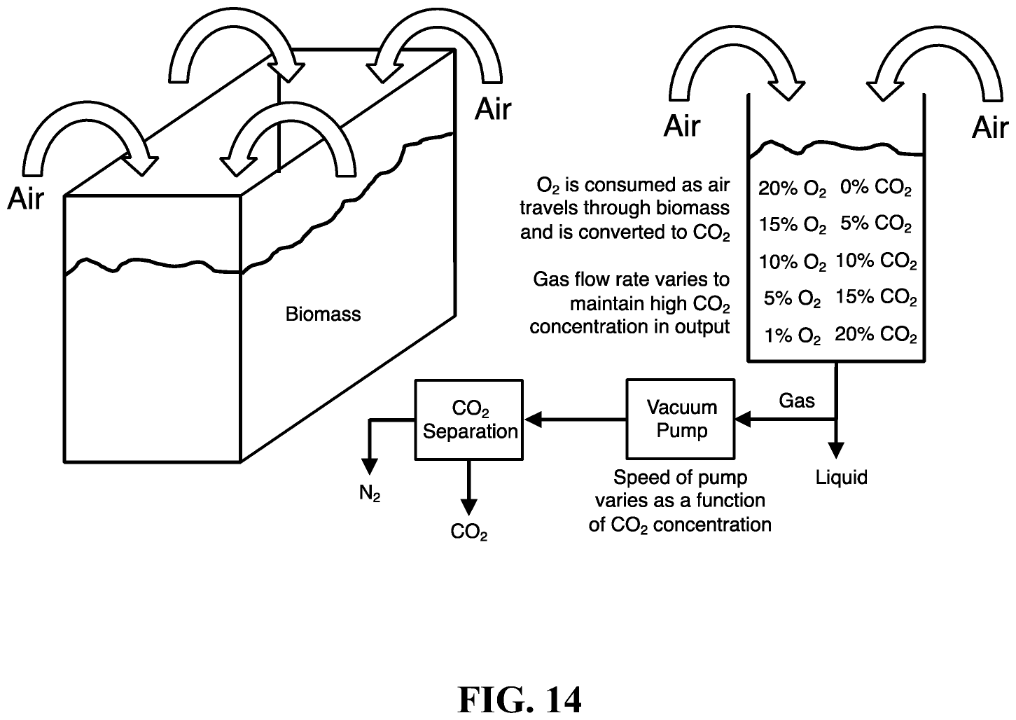

Referring to FIG. 14, embodiments of the present disclosure also include methods of composting and capturing CO₂ using a post-composting CO₂ capture system that involves a short incubation time for the gas. The short incubation time (also referred to as “retention time”) enables an open system with continuous flow of gas through the bed of biomass. Incubation time is defined as the amount of time the compost feedstock interacts with the gas before removal. In accordance with these embodiments, the bioreactor systems of FIG. 14 allow for incubation times to proceed until O₂ levels reach a level that is much lower than conventional compositing bioreactors. That is, the systems of FIG. 14 allow for the extracted gas to have a low O₂ concentration (e.g., <3 vol %). This approach contrasts with conventional composting technologies, which are specifically designed and operated to maintain high levels of O₂ (e.g., >15 vol %). The embodiments of the present disclosure were developed to utilize low O₂ concentrations for three primary reasons: 1) O₂ is designed to be consumed to generate CO₂, which is needed in the extracted gas product; 2) the extracted gas is designed to be low in non-CO₂ components to ensure efficient and cost-effective separation of CO₂; and 3) high concentrations of O₂ in the extracted gas pose a safety risk due to the reactive nature of O₂. For these and other reasons, the composting CO₂ and capture systems of the present disclosure are advantageous over conventional systems.

In accordance with these embodiments, the predetermined incubating time ranges from about 1 second to about 24 hours. In some embodiments, the predetermined incubating time ranges from about 1 second to about 16 hours. In some embodiments, the predetermined incubating time ranges from about 1 second to about 8 hours. In some embodiments, the predetermined incubating time ranges from about 1 second to about 4 hours. In some embodiments, the predetermined incubating time ranges from about 1 second to about 2 hours. In some embodiments, the predetermined incubating time ranges from about 1 second to about 1 hour. In some embodiments, the predetermined incubating time ranges from about 1 second to about 30 minutes. In some embodiments, the predetermined incubating time ranges from about 30 minutes to about 24 hours. In some embodiments, the predetermined incubating time ranges from about 1 hour to about 24 hours. In some embodiments, the predetermined incubating time ranges from about 2 hours to about 24 hours. In some embodiments, the predetermined incubating time ranges from about 4 hours to about 24 hours. In some embodiments, the predetermined incubating time ranges from about 8 hours to about 24 hours. In some embodiments, the predetermined incubating time ranges from about 16 hours to about 24 hours. In some embodiments, the predetermined incubating time ranges from about 1 hour to about 8 hours. In some embodiments, the predetermined incubating time ranges from about 2 hours to about 6 hours.

What is claimed is:

1. A method for composting and capturing CO₂, the method comprising:
inputting a biomass feedstock, one or more additives, and an initial gas composition into one or more bioreactors;
incubating the biomass feedstock and the initial gas composition during an incubation time; and
obtaining a compost and an extracted gas composition comprising CO₂.

2. The method of claim 1, wherein obtaining a compost and an extracted gas composition comprising CO₂ comprises post-composting CO₂ capture.

3. The method of claim 2, wherein the post-composting CO₂ capture comprises one or more of the following:
(i) inputting the initial gas composition into the one or more bioreactors, wherein the initial gas composition comprises air;
(ii) obtaining the extracted gas composition, wherein the extracted gas composition comprises one or more of CO₂ O₂, and/or N₂; or
(iii) obtaining the extracted gas composition, wherein the extracted gas composition is subjected to additional CO₂ capture to produce high purity CO₂.

4. The method of claim 3, wherein the additional CO₂ capture comprises at least one of absorption, adsorption, and/or membrane separation.

5. The method of claim 1, wherein obtaining a compost and an extracted gas composition comprising CO₂ comprises pre-composting CO₂ capture.

6. The method of claim 5, wherein the pre-composting CO₂ capture comprises one or more of the following:
(i) inputting the initial gas composition into the one or more bioreactors, wherein the initial gas composition comprises O₂ and/or CO_{2;}
(ii) obtaining the extracted gas composition, wherein the extracted gas composition comprises high purity CO_{2; or}
(iii) obtaining the extracted gas composition, wherein the extracted gas composition comprises high purity CO₂ and wherein the high purity CO₂ is captured directly from the bioreactor.

7. The method of any one of claims 1 to 6, wherein the biomass feedstock comprises one or more of organic biomass feedstock, food waste, animal waste, human waste, agricultural waste, forestry waste, industrial waste, lignocellulosic feedstock, and any combinations thereof.

8. The method of any one of claims 1 to 7, wherein the biomass feedstock is pre-treated, and wherein pre-treatment comprises steam treatment, chemical treatment, biochemical treatment, and/or mechanical treatment. oi The method of any one of claims 1 to 8, wherein the initial gas composition comprises one or more of N₂, CO₂, and/or O₂.

10. The method of any one of claims 1 to 9, wherein the incubation time ranges from about 1 second to about 100 days.

11. The method of any one of claims 1 to 10, wherein the biomass feedstock comprises a C:N ratio from about 20:1 to about 40:1.

12. The method of any one of claims 1 to 11, wherein the biomass feedstock comprises one or more of lignocellulose, starches, sugars, organic acids, polysaccharides, peptides, polypeptides, proteins, and/or lipids.

13. The method of any one of claims 1 to 12, wherein the biomass feedstock comprises particle sizes from about 1 mm to about 10 m.

14. The method of any one of claims 1 to 13, wherein the biomass feedstock comprises a moisture content from about 5 wt % to about 70 wt %.

15. The method of any one of claims 1 to 14, wherein the initial gas composition comprises one or more of air, steam, O₂, or CO₂.

16. The method of any one of claims 1 to 15, wherein the one or more additives comprise water, microbial inoculants, purified enzymes, silicate minerals, carbonate minerals, acids, and/or bases.

17. The method of any one of claims 1 to 16, wherein the incubation occurs at temperatures from about 30° C. to about 70° C.

18. The method of any one of claims 1 to 17, wherein the incubation occurs at pH values from about 3 to about 9.

19. The method of any one of claims 1 to 18, wherein the incubation occurs at bioreactor pressures from about 1 psia to about 100 psia.

20. The method of any one of claims 1 to 19, wherein composting and CO₂ capture include heat recovery.

21. A bioreactor for performing the method of any one of claims 1 to 20, wherein the bioreactor is configured to perform batch, semi-batch, or continuous composting and CO₂ capture.

22. The bioreactor of claim 21, wherein the bioreactor comprises at least one vacuum pump.

23. The bioreactor of claim 21 or claim 22, wherein the bioreactor comprises one or more valves.

24. The bioreactor of any one of claims 21 to 23, wherein the bioreactor comprises at least one knife gate valve and/or at least one ball valve.

25. The bioreactor of any one of claims 21 to 24, wherein the bioreactor comprises a static vessel, a screw reactor, and/or a rotating drum.

26. The bioreactor of any one of claims 21 to 25, wherein the bioreactor comprises a biomass plug and a back pressure damper configured to control gas pressure.

27. A system comprising the bioreactor of any one of claims 21 to 26, wherein the system is configured to perform batch, semi-batch, or continuous composting and CO₂ capture.
